(19) United States
(12) Patent Application Publication
(10) Pub. No.: US 2026/0032424 A1
(43) Pub. Date: Jan. 29, 2026

(54) BATTERY ENHANCEMENTS FOR A VULNERABLE ROAD USER (VRU) DEVICE

(71) Applicant: QUALCOMM Incorporated, San Diego, CA (US)

(72) Inventors: Mohit NARULA, San Diego, CA (US); Chaitanya MEHTA, San Diego, CA (US); Arzu KARAER, San Diego, CA (US); Mayank MANOCHA, San Diego, CA (US); Dan VASSILOVSKI, Del Mar, CA (US); Deviprasad PUTCHALA, San Diego, CA (US)

(21) Appl. No.: 18/786,225

(22) Filed: Jul. 26, 2024

(51) Int. Cl. H04W 8/22; H04W 4/40

(52) U.S. Cl. CPC H04W 8/22; H04W 4/40

(57) ABSTRACT

Systems and techniques are described herein for wireless communications. For example, a first device can detect a second device within a region of interest of a scene. Based on detecting the second device within the region of interest of the scene, the first device can transmit a message mute request to the second device, the message mute request requesting the second device to modify transmission of messages (e.g., by stopping transmission of the messages or reducing a frequency of transmission of the messages). In some cases, the first device can transmit a message resume request to the second device requesting the second device to resume transmission of the messages or increase the frequency of transmission of the messages.

### FIELD

The present disclosure generally relates to wireless communications. For example, aspects of the present disclosure relate to battery enhancements for a vulnerable road user (VRU) device.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Aspects of wireless communication may comprise direct communication between devices, such as in V2X, vehicle-to-vehicle (V2V), and/or device-to-device (D2D) communication. There exists a need for further improvements in V2X, V2V, and/or D2D technology. These improvements may also be applicable to other multi-access technologies and the telecommunication standards that employ these technologies.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for wireless communications. In some aspects, a first device for wireless communications is provided. The first device includes at least one transceiver, at least one memory, and at least one processor coupled to the at least one transceiver and the at least one memory, the at least one processor configured to: detect a second device within a region of interest of a scene; and based on detecting the second device within the region of interest of the scene, transmit, via the at least one transceiver, a message mute request to the second device, the message mute request requesting the second device to modify transmission of messages by stopping transmission of the messages or reducing a frequency of transmission of the messages.

In some aspects, a method of wireless communications at a first device is provided. The method includes: detecting a second device within a region of interest of a scene; and based on detecting the second device within the region of interest of the scene, transmitting a message mute request to the second device, the message mute request requesting the second device to modify transmission of messages by stopping transmission of the messages or reducing a frequency of transmission of the messages.

In some aspects, a non-transitory computer-readable medium having stored thereon instructions that, when executed by at least one processor, cause the at least one processor to: detect a second device within a region of interest of a scene; and based on detecting the second device within the region of interest of the scene, transmit, via at least one transceiver, a message mute request to the second device, the message mute request requesting the second device to modify transmission of messages by stopping transmission of the messages or reducing a frequency of transmission of the messages.

In some aspects, a first device for wireless communications is provided. The first device includes: means for detecting a second device within a region of interest of a scene; and means for transmitting, based on detecting the second device within the region of interest of the scene, a message mute request to the second device, the message mute request requesting the second device to modify transmission of messages by stopping transmission of the messages or reducing a frequency of transmission of the messages.

In some aspects, a first device for wireless communications is provided. The first device includes at least one transceiver, at least one memory, and at least one processor coupled to the at least one transceiver and the at least one memory, the at least one processor configured to: receive, from a second device via the at least one transceiver, a message mute request based on the first device being within a region of interest of a scene, the message mute request requesting the first device to modify transmission of messages by stopping transmission of the messages or reducing a frequency of transmission of the messages; and based on the message mute request, determine whether to modify transmission of the messages.

In some aspects, a method of wireless communications at a first device is provided. The method includes: receiving, from a second device, a message mute request based on the first device being within a region of interest of a scene, the message mute request requesting the first device to modify transmission of messages by stopping transmission of the messages or reducing a frequency of transmission of the messages; and based on the message mute request, determining whether to modify transmission of the messages.

In some aspects, a non-transitory computer-readable medium having stored thereon instructions that, when executed by at least one processor, cause the at least one processor to: receive, from a second device via at least one transceiver, a message mute request based on the first device being within a region of interest of a scene, the message mute request requesting the first device to modify transmission of messages by stopping transmission of the messages or reducing a frequency of transmission of the messages; and based on the message mute request, determine whether to modify transmission of the messages.

In some aspects, a first device for wireless communications is provided. The first device includes: means for receiving, from a second device, a message mute request based on the first device being within a region of interest of a scene, the message mute request requesting the first device to modify transmission of messages by stopping transmission of the messages or reducing a frequency of transmission of the messages; and means for determining, based on the message mute request, whether to modify transmission of the messages.

In some aspects, the first device and/or second is, includes, or is part of, a vehicle (e.g., an automobile, truck, etc., or a component or system of an automobile, truck, etc.), a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a robotics device, a roadside unit (RSU), or other device. In some aspects, the apparatus includes radio detection and ranging (radar) for capturing radio frequency (RF) signals. In some aspects, the apparatus includes one or more light detection and ranging (LIDAR) sensors, radar sensors, or other light-based sensors for capturing light-based (e.g., optical frequency) signals. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors, which can be used for determining a location of the apparatuses, a state of the apparatuses (e.g., a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating details of an example wireless communication system, in accordance with some aspects of the disclosure.

FIG. 2 is a block diagram illustrating examples of a base station and a user equipment (UE), in accordance with some aspects of the disclosure.

FIG. 3 shows a diagram illustrating an example disaggregated base station architecture, in accordance with some aspects of the disclosure.

FIG. 4 is a block diagram illustrating an example wireless communication system that supports a safety system, in accordance with some aspects of the disclosure.

FIG. 5 is a diagram illustrating examples of images showing a region of interest (ROI) and a field of view (FOV) of a camera associated with a device, in accordance with some aspects of the disclosure.

FIG. 6 is a diagram illustrating an example of a system for battery enhancements for a V2X-enabled VRU device, in accordance with some aspects of the disclosure.

FIG. 7 is a diagram illustrating an example of signaling for battery enhancements for a V2X-enabled VRU device, in accordance with some aspects of the disclosure.

FIG. 8 is a flow diagram illustrating an example of a process for wireless communications, in accordance with some aspects of the disclosure.

FIG. 9 is a flow diagram illustrating an example of another process for wireless communications, in accordance with some aspects of the disclosure.

FIG. 10 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Wireless communications systems are deployed to provide various telecommunication services, including telephony, video, data, messaging, broadcasts, among others. Wireless communications systems have developed through various generations. A fifth generation (5G) mobile standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users.

Vehicles are an example of systems that can include wireless communications capabilities. For example, vehicles (e.g., automotive vehicles, autonomous vehicles, aircraft, maritime vessels, among others) can communicate with other vehicles and/or with other devices that have wireless communications capabilities. Wireless vehicle communication systems encompass vehicle-to-vehicle (V2V), vehicle-to-infrastructure (V2I), vehicle-to-network (V2N), and vehicle-to-pedestrian (V2P) communications, which are all collectively referred to as vehicle-to-everything (V2X) communications. V2X communications is a vehicular communication system that supports the wireless transfer of information from a vehicle to other entities (e.g., other vehicles, pedestrians with smart phones, equipped vulnerable road users (VRUs), such as bicyclists, and/or other traffic infrastructure) located within the traffic system that may affect the vehicle. The main purpose of the V2X technology is to improve road safety, fuel savings, and traffic efficiency.

In a V2X communication system, information is transmitted from vehicle sensors (and other sources) through wireless links to allow the information to be communicated to other vehicles, pedestrians, VRUs, and/or traffic infrastructure. The information may be transmitted using one or more vehicle-based messages, such as cellular-vehicle-to-everything (C-V2X) messages, which can include Sensor Data Sharing Messages (SDSMs), Basic Safety Messages (BSMs), Cooperative Awareness Messages (CAMs), Collective Perception Messages (CPMs), Decentralized Environmental Messages (DENMs), and/or other types of vehicle-based messages. By sharing this information with other vehicles, the V2X technology improves vehicle (and driver) awareness of potential dangers to help reduce collisions with other vehicles and entities. In addition, the V2X technology enhances traffic efficiency by providing traffic warnings to vehicles of potential upcoming road dangers and obstacles such that vehicles may choose alternative traffic routes.

As previously mentioned, the V2X technology includes V2V communications, which can also be referred to as peer-to-peer communications. V2V communications allows for vehicles to directly wireless communicate with each other while on the road. With V2V communications, vehicles can gain situational awareness by receiving information regarding upcoming road dangers (e.g., unforeseen oncoming vehicles, accidents, and road conditions) from the other vehicles.

The IEEE 802.11p Standard supports (uses) a dedicated short-range communications (DSRC) interface for V2X wireless communications. Characteristics of the IEEE 802.11p based DSRC interface include low latency and the use of the unlicensed 5.9 Gigahertz (GHz) frequency band. C-V2X was adopted as an alternative to using the IEEE 802.11p based DSRC interface for the wireless communications. The 5G Automotive Association (5GAA) supports the use of C-V2X technology. In some cases, the C-V2X technology uses Long-Term Evolution (LTE) as the underlying technology, and the C-V2X functionalities are based on the LTE technology. C-V2X includes a plurality of operational modes. One of the operational modes allows for direct wireless communication between vehicles over the LTE sidelink PC5 interface. Similar to the IEEE 802.11p based DSRC interface, the LTE C-V2X sidelink PC5 interface operates over the 5.9 GHz frequency band. Vehicle-based messages, such as BSMs and CAMs, which are application layer messages, are designed to be wirelessly broadcasted over the 802.11p based DSRC interface and the LTE C-V2X sidelink PC5 interface.

The detection and tracking of a VRU (e.g., such as a pedestrian, a bicyclist, a motorcyclist, scooter rider, a road worker, a wheelchair user, or a skateboard rider) is important for road safety. In some cases, a system can detect, track, and report the location, position, and/or speed of VRUs that are located within a field of view (FOV) of a camera (e.g., an image sensor) of a roadside unit (RSU). Within the FOV of the camera of the RSU is a region of interest (ROI). Identifying (and maintaining) an ROI requires that the installation, orientation, and hardware specifications of the camera of the RSU remain the same. The camera of the RSU periodically requires calibration of the FOV because sometimes the orientation of the camera may change (e.g., the camera may be moved due to strong winds caused by a storm). Movement of the camera without calibration afterwards can cause the FOV or ROI of the camera to change. The calibration of the camera may be performed by manual or automatic methods. A well calibrated camera of an RSU is important for detecting and tracking a VRU reliably and accurately for road safety.

A V2X-enabled VRU device (e.g., a smart phone associated with a VRU, such as a pedestrian) can transmit standardized pedestrian safety messages (PSMs). The PSMs may be transmitted periodically. PSMs can include information that may be obtained from sensors associated with the V2X-enabled VRU device or the associated VRU. The PSMs can be transmitted by the V2X-enabled VRU device through wireless links to other VRUs, vehicles, pedestrians, and/or traffic infrastructure. Sharing this information allows for awareness of the location and travel of a VRU associated with the V2X-enabled VRU device to help reduce collisions with the VRU and other vehicles and entities.

Currently, there are systems where a camera of a V2X-enabled RSU can detect a VRU located within the FOV or ROI of the V2X-enabled RSU. Based on that detection, the V2X-enabled RSU can generate and transmit PSMs including information regarding the location and speed of the detected VRU for safety purposes.

The PSMs may be transmitted periodically, such as one PSM may be transmitted very one second, which can cause a smart phone (e.g., a VRU device associated with a VRU, such as a pedestrian) to require additional battery resources as well as an increased computational load on the application processor running on the smart phone. The transmissions of the PSMs may require users (e.g., a VRU, such as a pedestrian, associated with the smart phone) to allow permissions to share real-time location information, which can increase the rate by which a smart phone's battery gets consumed. There can be some privacy or security concerns where a user may not be comfortable sharing the accurate position information, for example to a third party cloud service.

In another case, if a VRU (e.g., a pedestrian or bicyclist) is carrying more than one V2X-enabled VRU device (e.g., a bicyclist is carrying a V2X-enabled smart phone and a V2X-enabled smart watch), transmission of PSMs from both of these V2X-enabled VRU devices may be redundant or unnecessary. It may seem obvious for the VRU (e.g., pedestrian or bicyclist) to turn “off” the V2X-enabled safety system (e.g., which generates and transmits PSMs) on one of the V2X-enabled VRU devices (e.g., the smart phone) to conserve the battery of that V2X-enabled VRU device (e.g., the smart phone). However, in doing so, the VRU (e.g., pedestrian or bicyclist) may mistakenly leave the other V2X-enabled VRU device (e.g., the smart watch) home and, as such, the VRU (e.g., pedestrian or bicyclist) can have higher chances of experiencing a collision.

In yet another case, if a VRU (e.g., a pedestrian or bicyclist) is traveling inside of a tunnel or through an area of poor GNSS coverage, the position estimates generated by the V2X-enabled VRU device (e.g., associated with the VRU) for itself can have errors. The Society of Automotive Engineers (SAE) has provisions (e.g., SAE J2735[5]) where positional parameters encoded in PSMs can be used to triangulate the position of a VRU. However, if the position estimates are highly inaccurate, an accurate position of the VRU may not be determined via the triangulation. As such, incorrect estimates in periodic PSMs may lead to false alarms and inefficiencies.

Currently, there are many applications (e.g., available in Google PlayStore) that can generate false position reports of a V2X-enabled VRU device. Such applications may be used by a malicious user or an attacker such that the reported position in the PSM is not an accurate position of the VRU. Generating and transmitting false position reports (e.g., within PSMs) can increase the rate of false alarms and misdetections that may affect the safety of the VRU.

As such, improved systems and techniques for transmission of PSMs that can solve for the above-mentioned issues while conserving the battery of a V2X-enabled VRU device can be beneficial.

In one or more aspects, systems, apparatuses, processes (also referred to as methods), and computer-readable media (collectively referred to herein as “systems and techniques”) are described herein for providing battery enhancements for a V2X-enabled VRU device.

Various aspects relate generally to wireless communications. Some aspects more specifically relate to systems and techniques that provide solutions that can modify the transmissions of PSMs by a V2X-enabled VRU device to conserve a battery of the V2X-enabled VRU device. In one or more examples, an RSU can detect a VRU. This detection can trigger the RSU to transmit, to the VRU, a message mute request. The message mute request may include coordinates of an ROI of the RSU (e.g., detected within a field of view (FOV) of a camera of the RSU based on one or more images captured by the camera), the coordinates of the RSU itself, a timestamp for transmission of the message mute request, security certificates to be used for communications with the RSU, a timer value indicating a duration of time for stopping transmission of the PSMs, a mute bitmask indicating stopping one or more transmissions of the PSMs, and/or a device identification (ID) for the V2X-enabled VRU device. The VRU may validate this information within the message mute request, and may accept the message mute request by modifying its transmissions of the PSMs accordingly. The RSU may periodically (or aperiodically) track the movement of the VRU. If the RSU determines that the VRU is located within a threshold distance from an edge of an ROI (e.g., which makes it appear that the VRU is leaving the ROI), the VRU may resume transmission of the PSMs.

In one or more aspects, during operation of the systems and techniques for battery enhancements for a V2X-enabled VRU device, a first device (e.g., an RSU) can detect a second device (e.g., a V2X-enabled VRU device associated with a VRU, such as a pedestrian, a bicyclist, a motorcyclist, scooter rider, a road worker, a wheelchair user, or a skateboard rider) within a region of interest of a scene. The region of interest is within a field of view of the first device (e.g., a field of view of at least one camera of the first device). In some cases, the first device can detect the second device within the region of interest based on one or more images captured by the first device (e.g., the at least one camera of the first device). Based on detecting the second device within the region of interest of the scene, the first device can transmit a message mute request to the second device. In one or more examples, the message mute request can request the second device to modify transmission of messages, such as by stopping transmission of the messages or reducing a frequency of transmission of the messages. In some aspects, the first device can transmit a message resume request to the second device. In one or more examples the message resume request can request the second device to resume transmission of the messages or increase the frequency of transmission of the messages. In some aspects, the message mute request indicates a time duration for the modifying the transmission of the messages by the second device. For example, according to some examples, after the time duration ends, the second device may resume transmission of the messages or increase the frequency of transmission of the messages (e.g., to a frequency at which the second device transmitted messages prior to the message mute request).

In one or more examples, the first device can transmit messages (e.g., periodic messages) for the second device in response to transmitting the message mute request. In some examples, the first device can cease transmission of the messages for the second device in response to transmitting the message resume request.

In some examples, the message mute request can include one or more parameters. In one or more examples, the one or more parameters can include coordinates (e.g., cartesian coordinates or latitude and longitude coordinates) of a region of interest (e.g., a region of interest polygon) within the field of view of the first device, coordinates of a location of the first device, a timestamp indicating a time of transmission by the first device of the message mute request, one or more safety certificates for communications, a timer value indicating a duration of time (e.g., in seconds) for modifying the transmission of the messages, a mute bitmask indicating stopping one or more transmissions of the messages, a device identification associated with the second device, any combination thereof, and/or other parameters.

In one or more examples, the message mute request can include a mute bitmask including a plurality of bits, where each bit of the plurality of bits can indicate a particular message transmission the second device is not to transmit. In some examples, the first device can receive a rejection message from the second device indicating rejection of the message mute request by the second device.

In one or more examples, the message resume request can be transmitted based on determining a timer value has expired, detecting movement of the second device by greater than a threshold amount, and/or detecting the second device leaving a region of interest within the field of view of the first device. In some examples, detecting the movement of the second device by greater than the threshold amount can include detecting a heading and/or speed of the second device changes by more than the threshold amount. In one or more examples, the first device can detect the second device is leaving the region of interest based on determining the second device is within a threshold distance from an edge of the region of interest.

In some examples, the messages can be V2X messages. In one or more examples, the V2X messages can include pedestrian safety messages (PSMs). In some examples, the first device can be an RSU. In one or more examples, the second device can be associated with a VRU. In some examples, the request to modify transmission of the messages can include a request to stop transmission of the messages or to reduce a frequency of transmission of the messages.

In one or more aspects, during operation of the systems and techniques for battery enhancements for a V2X-enabled VRU device, a first device (e.g., a V2X-enabled VRU device associated with a VRU, such as a pedestrian, a bicyclist, a motorcyclist, scooter rider, a road worker, a wheelchair user, or a skateboard rider) can receive, from a second device (e.g., an RSU), a message mute request based on the first device being within region of interest of a scene (e.g., with the region of interest being within a field of view of the second device, such as at least one camera of the second device). In one or more examples, the message mute request can request the first device to modify transmission of messages (e.g., by stopping transmission of the messages or reducing a frequency of transmission of the messages). Based on the message mute request, the first device can determine whether to modify transmission of the messages.

In some cases, the first device can receive, from the second device, a message resume request. In one or more examples, the message resume request can request the first device to resume transmission of the messages or increase the frequency of transmission of the messages. In some aspects, the message mute request indicates a time duration for the modifying the transmission of the messages by the first device. For example, according to some examples, after the time duration ends, the first device may resume transmission of the messages or increase the frequency of transmission of the messages (e.g., to a frequency at which the first device transmitted messages prior to the message mute request).

The first device can resume transmission of the messages or increase the frequency of transmission of the messages. For instance, the first device can resume transmission of the message based on the message resume request or based on the time duration in the message mute request. In some cases, as described herein, the first device (e.g., the V2X-enabled VRU device) can automatically resume transmissions if a timer (e.g., received in the mute request) has expired. In some examples, as described herein, the first device (e.g., the V2X-enabled VRU device) can automatically resume transmissions if the first device determines/detects or derives that its position, heading, and/or speed has changed by a certain amount. In such examples, even though the timer has not expired, the first device can resume otherwise muted transmissions. In such examples, the first device may not wait for the resume request from the RSU.

In one or more examples, the first device can modify transmission of the messages based on the message mute request. In some cases, modifying transmission of the messages can include stopping transmission of the messages or reducing a frequency of transmission of the messages. In one or more examples, the first device can determine to reject the message mute request, and transmit, to the second device, a rejection message based on determining to reject the message mute request. In some cases, the first device can determine to reject the message mute request based on a security check.

In some examples, the message mute request can include one or more parameters. In one or more examples, the one or more parameters can include coordinates of a region of interest within the field of view of the second device, coordinates of a location of the second device, a timestamp indicating a time of transmission by the second device of the message mute request, one or more safety certificates for communications, a timer value indicating a duration of time for modifying the transmission of the messages, a mute bitmask indicating stopping one or more transmissions of the messages, and/or a device identification associated with the first device.

In one or more examples, the message mute request can include a mute bitmask including a plurality of bits, where each bit of the plurality of bits can indicate a particular message transmission the first device is not to transmit. In some examples, the message resume request can be based on a timer value expiring, movement of the first device by greater than a threshold amount, and/or the first device leaving a region of interest within the field of view of the first device.

In some examples, the messages can be V2X messages. In one or more examples, the V2X messages can include PSMs. In some examples, the first device can be associated with a VRU. In one or more examples, the second device can be an RSU.

Particular aspects of the subject matter described in this disclosure can be implemented to realize one or more of the following potential advantages. In one or more examples, the systems and techniques provide a benefit of an RSU camera, located within a parking garage or tunnel, providing accurate positional estimates for a VRU, while the V2X-enabled VRU device is conserving its battery. For example, parking garages and road tunnels are typically equipped with cameras (e.g., that may be associated with RSUs). Within parking garages or road tunnels, the GNSS coverage of a V2X-enabled VRU device can be poor. With the systems and techniques, not only can batteries of V2X-enabled VRU devices be preserved, but accurate position estimates or reports can be provided to the V2X-enabled VRU devices that are also located inside the tunnel with poor GNSS coverage. As such, even though a VRU is traveling inside a tunnel, an RSU camera within that tunnel may be able to provide accurate positional estimates of that VRU, while the V2X-enabled VRU device is conserving its battery.

As such, there is minimal to no performance degradation, even though the VRU is located inside a tunnel with poor GNSS coverage.

In some examples, the systems and techniques provide a benefit of an RSU camera detecting an attacker spoofing the position of a VRU. For example, an attacker spoofing (e.g., faking) the position of a VRU can be easily detected by an RSU camera because the camera has its own object detection capabilities. If the RSU is receiving PSMs (supposedly transmitted from the V2X-enabled VRU device) containing false information, the RSU can flag the transmitting entity (e.g., an attacker) of the PSMs to the authorities.

In one or more examples, the systems and techniques provide the benefits of, by muting the PSM messages or using a bitmap to reduce the PSM transmissions, reducing the computational load on the application processor, improving the over-the-air efficiency, and conserving the battery of the V2X-enabled VRU device.

In some examples, the systems and techniques provide a benefit of improving V2X-enabled VRU device battery degradation. For example, an FOV or ROI of an RSU's camera is designed to cover a large area on the ground, which can include sidewalks and crosswalks. For example, the ROI can be detected in one or more images captured by the camera of the RSU, such as using one or more image processing techniques (e.g., object detection, object classification, semantic or instance segmentation, any combination thereof, and/or other image processing technique). Such image processing techniques can be performed using one or more computer vision algorithms, using one or more machine learning systems (e.g., one or more neural network models, or using other algorithms or systems). As there is a large coverage arca for the FOV or ROI, a V2X-enabled VRU device can mute PSM transmissions for a long period of time and, as such, the V2X-enabled VRU device's battery can be conserved.

In one or more examples, the systems and techniques provide a benefit of a manufacturer being able to charge a service fee or a license fee to enable the systems and techniques in V2X-enabled devices. In some examples, the manufacturer can collaborate with public utility authorities, such as Police Departments and transportation departments, to authorize, deploy, and activate the systems and techniques on V2X-enabled devices. In one or more examples, over-the-air software updates may be applied to existing camera-enabled RSU networks to take benefit of the systems and techniques.

Additional aspects of the present disclosure are described in more detail below.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example, implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km2), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mm Wave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHZ, and the like bandwidth. For other various outdoor and small cell coverage deployments of TDD greater than 3 GHZ, subcarrier spacing may occur with 30 kHz over 80/100 MHZ bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

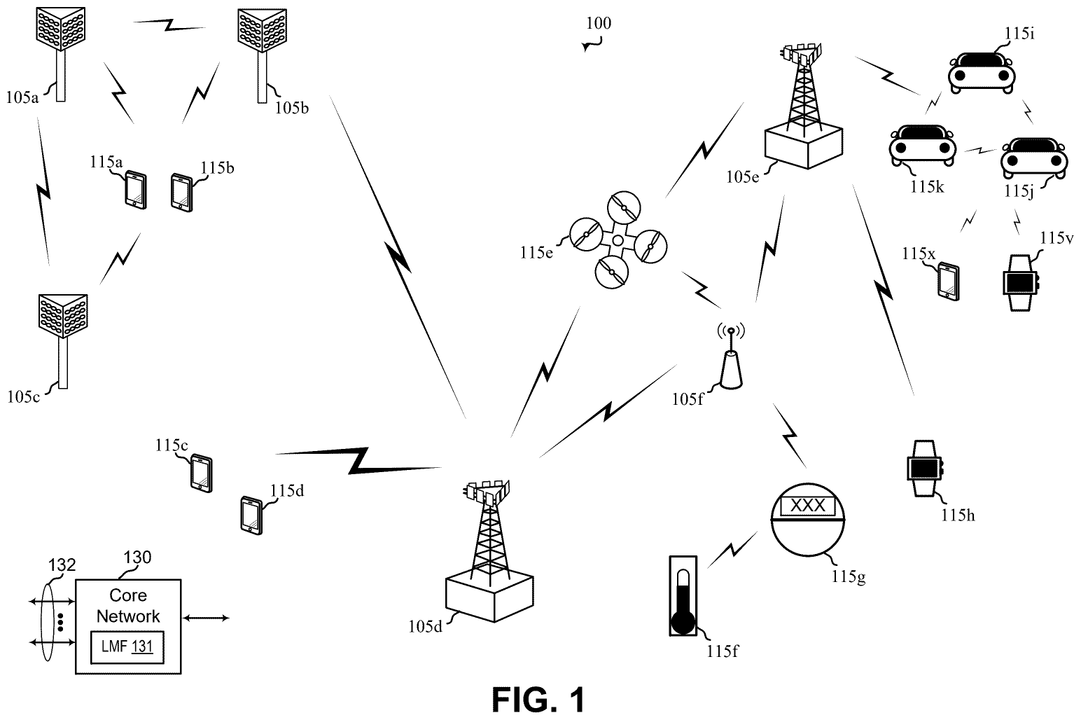

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage arca, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FI105rG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (COMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115c, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105c. Additionally, V2V mesh network may include or correspond to a vehicle-to-everything (V2X) network between UEs 115i-115k and one or more other devices, such as UEs 115x, 115y.

Base stations 105 may communicate with a core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

Core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to a management function, such as a Location Management Function (LMF) 131, a Sensing Management Function (SnMF), or an Access and Mobility Management Function (AMF), which is an entity in the 5G Core Network (5GC) supporting various functionality, such as managing support for different location services for one or more UEs. The SnMF may be configured to manage support for sensing operations for one or more sensing operations or sensing services for one or more devices, such as one or more UEs 115, one or more base stations 105, one or more TRPs, or a combination thereof. For example, the SnMF may include one or more servers, such as multiple distributed servers. Base stations 105 may forward sensing messages to the SnMF and may communicate with the SnMF via a NR Positioning Protocol A (NRPPa). The SnMF is configured to control sensing parameters for UEs 115 and the SnMF can provide information to the base stations 105 and UE 115 so that action can be taken at UE 115, base station 105, or another device. The LMF 131 may include one or more servers, such as multiple distributed servers. Base stations 105 may forward location messages to the LMF 131 and may communicate with the LMF 131 via a NR Positioning Protocol A (NRPPa). The LMF 131 is configured to control the positioning parameters for UEs 115 and the LMF 131 can provide information to the base stations 105 and UE 115 so that action can be taken at UE 115. In some implementations, UE 115 and base station 105 are configured to communicate with the LMF 131 via the AMF.

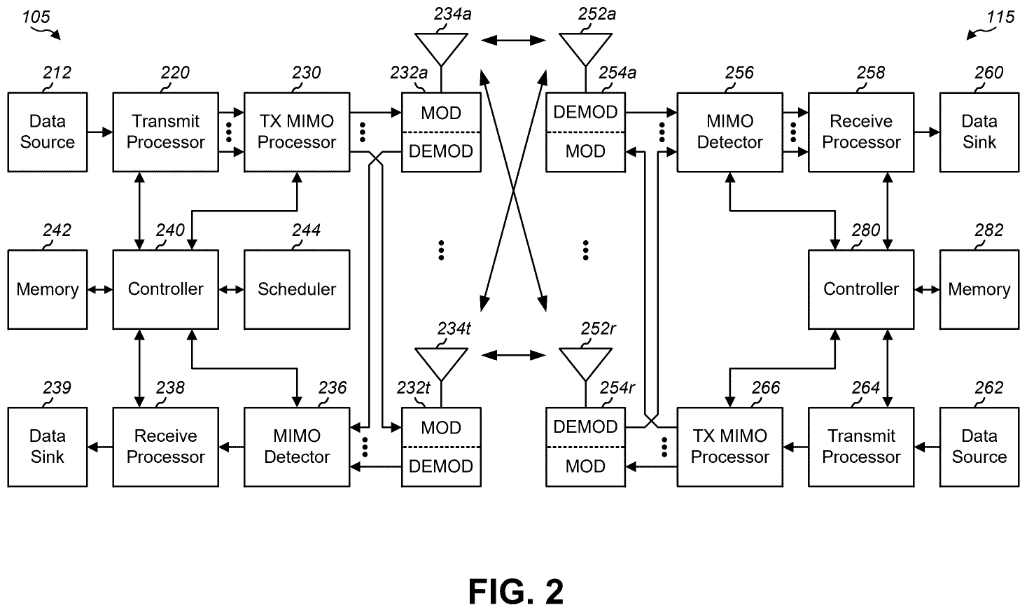

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

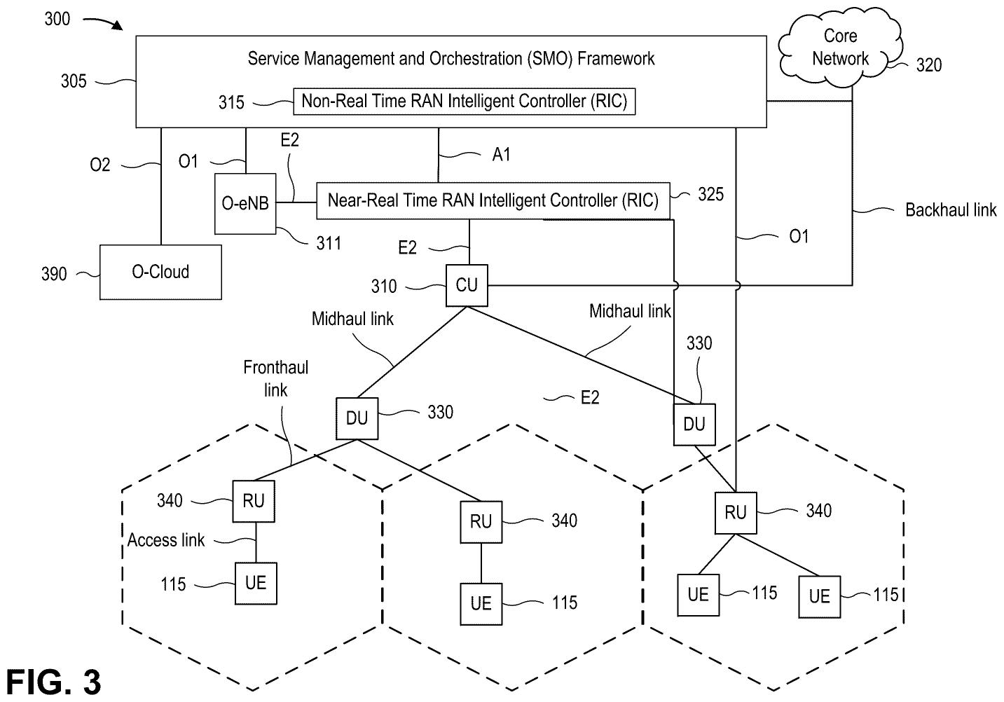

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). Core network 320 may include or correspond to core network 130. A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 115 via one or more radio frequency (RF) access links. In some implementations, the UE 115 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RUs 340 can be implemented to handle over the air (OTA) communication with one or more UEs 115. In some implementations, real-time and non-real-time aspects of control and user plane communication with the RUs 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-NB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As described herein, a node (which may be referred to as a node, a network node, a network entity, or a wireless node) may include, be, or be included in (e.g., be a component of) a base station (e.g., any base station described herein), a transmission and reception point (TRP), a UE (e.g., any UE described herein), a network controller, an apparatus, a device, a computing system, an integrated access and backhauling (IAB) node, a distributed unit (DU), a central unit (CU), a remote unit (RU), a core network, a location management function (LMF), a sensing management function (SnMF), a server, and/or a another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

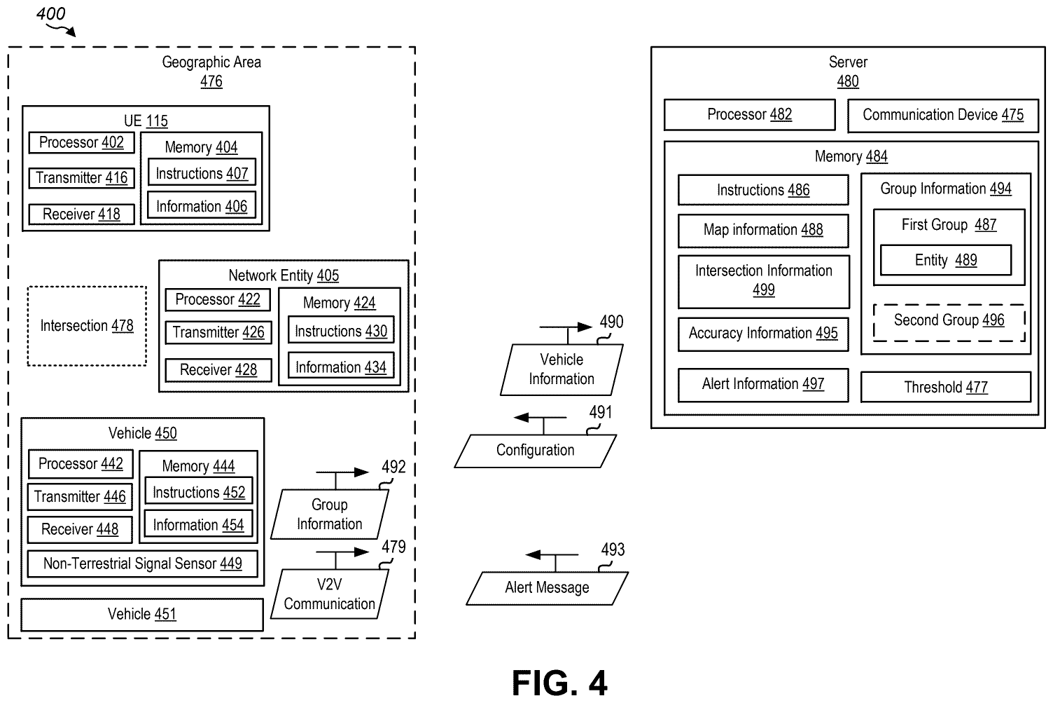

FIG. 4 is a block diagram of an example wireless communications system 400 that supports a safety system according to one or more aspects. In some examples, wireless communications system 400 may implement aspects of wireless network 100. Additionally, or alternatively, wireless communications system 400 may include or correspond to a vulnerable road user (VRU) alert system. Wireless communications system 400 includes UE 115, vehicle 450, vehicle 451, a network entity 405, and a server 480. In some implementations, vehicle 450 or 451 may include or correspond to UEs 115i, 115j, 115k to FIG. 1. It is noted that vehicle 450 and 451 may also be referred to as a mobile entity—e.g., vehicle 450 is a first mobile entity and vehicle 451 is a second mobile entity. In some implementations, network entity 405 and server 480 may be individually or collectively referred to as a network, a network device, or a network system (e.g., a safety system). Although one UE 115, two vehicles 450 and 451, one network entity 405, and one server 480 are illustrated, in some other implementations, wireless communications system 400 may generally include multiple UEs 115, one or more vehicles 450, 451, multiple network entities 405, multiple servers 480, or a combination thereof.

Although one UE 115 and one base station 105 are illustrated, in some other implementations, wireless communications system 400 may generally include multiple UEs 115, multiple base stations 105, or a combination thereof. In some implementations, UE 115 may be a vehicle, such as described further herein at least with reference to FIG. 11. Additionally, or alternatively, UE 115 may include or correspond to a device of a pedestrian (e.g., a VRU). For example, the device of the pedestrian may include or correspond to UE 115a, 115b, 115c, 115d, 114h, 115x, or 115y, as illustrative, non-limiting examples.

In some implementations, wireless communication system 400 includes a V2X wireless communication system. V2X is a communication system in which information is passed between a vehicle and other entities within the wireless communication network that provides the V2X services. The V2X services may include services for Vehicle-to-Vehicle (V2V), Vehicle-to-Pedestrian (V2P), Vehicle-to-Infrastructure (V2I), and Vehicle-to-Network (V2N). One or more V2X standards aim to develop or support an Advanced Driver Assistance System (ADAS), which assist a driver with critical decisions, such as lane changes, speed changes, overtaking speeds, etc. Low latency communications may be used in V2X and, are therefore suitable for precise positioning. For example, positioning techniques, such as time of arrival (TOA), time difference of arrival (TDOA) or observed time difference of arrival (OTDOA), or any other cellular positioning technique, may be enhanced using assistance from V2X.

In general, there may be at least two modes of operation for V2X services, as defined in Third Generation Partnership Project (3GPP) TS 23.285. One mode of operation uses direct wireless communications between V2X entities when the V2X entities are within range of each other. The other mode of operation uses network based wireless communication between entities. The two modes of operation may be combined or other modes of operation may be used if desired.

The wireless communication of a V2X wireless communication system may be over Proximity-based Services (ProSe) Direction Communication (PC5) reference point as defined in 3GPP TS 23.303, and may use wireless communications under Institute of Electrical and Electronics Engineers (IEEE) 1609, Wireless Access in Vehicular Environments (WAVE), Intelligent Transport Systems (ITS), and IEEE 802.11p, on the ITS band of 5.9 GHZ, or other wireless connections directly between entities.

In some implementations, wireless communications system 400 is associated with a geographic area 476. Geographic area 476 may include one or more roads that include at least one intersection 478. Intersection 478 may be any type of intersection, such as a “T” intersection, a “+” intersection, a “Y” intersection, a roundabout intersection, or other type of intersection. Additionally, the one or more roads may be associated with multiple paths that each lead toward or into intersection 478. For example, the one or more paths may be configured for vehicular traffic, pedestrian traffic, or a combination thereof. The one more roads or one or more paths may be linear, non-linear, curved, or a combination thereof. To illustrate, the one or more paths may be associated with a road, a car lane, a bus lane, a bike lane, a sidewalk, or a combination thereof, as illustrative, non-limiting examples. In some implementations, intersection 478 may be associated with a geo-fenced portion of geographic arca 476.

In some implementations, UE 115, network entity 405, vehicle 450, and vehicle 451 may be positioned within geographic area 476. Although each of UE 115, network entity 405, vehicle 451, and vehicle 450 is described and shown as being positioned within geographic arca 476, in other implementations, one or more of UE 115, network entity 405, vehicle 450, or vehicle 451 may be positioned outside of geographic area 476. Additionally, or alternatively, UE 115, vehicle 450, or vehicle 451 may be traveling towards or positioned within intersection 478. In some implementations, UE 115, vehicle 450, vehicle 451, or a combination thereof, are mobile devices. Network entity 405 may include a base station, such as base station 105, an access point, a roadside unit, another UE or vehicle, or part of a core network, such as core network 130. Network entity 405 may be stationary or mobile. Server 480 may include a server, base station 105, core network 130, or other device or system. For example, server 480 includes a car 2 cloud (C2C) server. In some implementations, server 480 is or includes LMF 131.

In some implementations, UE 115, vehicle 450, or vehicle 451 is configured to communicate with another of UE 115, vehicle 450, or vehicle 451 using a sidelink (SL) link/interface (e.g., using sidelink communication). Additionally, or alternatively, UE 115, vehicle 450, vehicle 451, or a combination thereof, is configured to communicate with network entity 405 using a sidelink (SL) link/interface (e.g., using sidelink communication) or a Uu link/interface (e.g., using Uu communication). Server 480 may be in communication with (e.g., communicatively coupled to) UE, vehicle 450, or network entity 405 via a cellular network. Server 480 may be configured to be aware of a situational awareness (e.g., a position, a heading, a speed, etc.) of UE 115 or vehicle 450 based on information, such as a vehicle/VRU,) based on a safety message, such as a basic safety message (BSM) message (for vehicle 450), a personal safety message (PSM) message (for UE 115), a collective perception message (CPM), or a combination thereof, as illustrative, non-limiting examples. Additionally, or alternatively, server 480 may be aware of the maps of or associated with geographic area 476, such as a map that indicates a nature of local intersections (e.g., 478), stop sign, traffic lights in geographic area, or other information, as illustrative, non-limiting examples. For example, a map or map data associated with geographic area 476 may include or correspond to map information 488, as described further herein.

In some implementations, a BSM may include or indicate information (e.g., BSM information), such as position, motion, control, size, an event, or a combination thereof. The position may include or indicate latitude, longitude, elevation, positional accuracy. The motion may include or indicate a transmission setting, a speed, a heading, a steering wheel angle, an acceleration (e.g., a longitudinal acceleration, a lateral acceleration, a vertical acceleration, a yaw rate, or a combination thereof), or a combination thereof. The control may include or indicate a brake system status, such as braking or not braking, as illustrative, non-limiting examples. The size may include or indicate a vehicle size, such a weight, a length, a width, a height, a maximum number of passengers, or a combination thereof, as illustrative, non-limiting examples. The event may include, indicate, or be associated with hazard lights, a stop line violation, ABS, traction control, stability control, hazardous materials, emergency response, hard braking, lights changed, wipers changed, a flat tire, a disabled vehicle, an air bag deployment, or a combination thereof, as illustrative, non-limiting examples. In some implementations, the CP may include or indicate information about a detected object, an onboard sensor, or a combination thereof. The CPM may include, correspond to, or be defined by ETSI ITS Intelligent Transport System (ITS) standard. As an illustrate, non-limiting example, the CPM may include or indicate an object ID, an object description, a local sensor perception, a neighboring vehicle perception, an RSU perception, or a combination thereof.

UE 115 may include a device, such as a mobile device or a vehicle. In some implementations, UE 115 is a device that corresponds to a VRU. UE 115 may include a variety of components (such as structural, hardware components) used for carrying out one or more functions described herein. For example, these components may include one or more processors 402 (hereinafter referred to collectively as “processor 402”), and one or more memory devices 404 (hereinafter referred to collectively as “memory 404”). In some implementations, UE 115 may include an interface (e.g., a communication interface) that includes transmitter 416, receiver 418, or a combination thereof. Processor 402 may be configured to execute instructions 407 stored in memory 404 to perform the operations described herein. In some implementations, processor 402 includes or corresponds to one or more of receive processor 258, transmit processor 264, and controller 280, and memory 404 includes or corresponds to memory 282.

Memory 404 includes or is configured to store instructions 407 and information 406. Information 406 may include capability information, location information, travel information, or a combination thereof. Information 406 may include or indicate a location or position (e.g., latitude, longitude, elevation, etc.), position accuracy, a heading, a speed (or a velocity), an altitude, a device state, a path history, a predicted path, a planned plan, an ID, a time, a steering wheel angle, acceleration, Yaw rate, brake system status, a device or vehicle size (e.g., a length, a width, a height, a weight, etc.), an event flag, or a combination thereof, as illustrative, non-limiting example.

UE 115 includes one or more transmitters 416 (hereinafter referred to collectively as “transmitter 416”), and one or more receivers 418 (hereinafter referred to collectively as “receiver 418”). Transmitter 416 is configured to transmit reference signals, control information and data to one or more other devices, and receiver 418 is configured to receive references signals, synchronization signals, control information and data from one or more other devices. For example, transmitter 416 may transmit signaling, control information and data to, and receiver 418 may receive signaling, control information and data from, base station 105, network entity 405, vehicle 450, or another UE 115. In some implementations, transmitter 416 and receiver 418 may be integrated in one or more transceivers. Additionally, or alternatively, transmitter 416 or receiver 418 may include or correspond to one or more components of UE 115 described with reference to FIG. 2

In some implementations, UE 115 may include one or more antenna arrays. The one or more antenna arrays may be coupled to transmitter 416, receiver 418, or a communication interface. The antenna array may include multiple antenna elements configured to perform wireless communications with other devices, such as with the base station 105. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of UE 115. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, UE 115 includes a non-terrestrial signal sensor. For example, the non-terrestrial signal sensor may include one or more global navigation satellite system (GNSS) sensors. A GNSS may include or correspond to a satellite constellation that provides positioning, navigation, and timing (PNT) services on a global or regional basis. Additionally, or alternatively, UE 115 may include one or more components as described herein with reference to UE 115. In some implementations, UE 115 is a 5G-capable UE, a 6G-capable UE, or a combination thereof.

Vehicle 450 may include a device, such as a mobile device or a vehicle. For example, vehicle 450 may include or correspond to UEs 115i, 115j, 115k of FIG. 1. In some implementations, vehicle 450 may include or correspond to a vehicle as described with reference to FIG. 11 or a network entity as described with reference to FIG. 13. Vehicle 450 may include a variety of components (such as structural, hardware components) used for carrying out one or more functions described herein. For example, these components may include one or more processors 442 (hereinafter referred to collectively as “processor 442”), one or more memory devices 444 (hereinafter referred to collectively as “memory 444”), one or more transmitters 416 (hereinafter referred to collectively as “transmitter 416”), one or more receivers 481 (hereinafter referred to collectively as “receiver 418”), and one or more non-terrestrial signal sensors 449 (“non-terrestrial signal sensor 449”). Processor 442 and memory 444 may include or correspond to processor 402 and memory 404, respectively. In some implementations, vehicle 450 may include an interface (e.g., a communication interface) that includes transmitter 446, receiver 448, or a combination thereof. Transmitter 446 and receiver 448 may include or correspond to transmitter 416 and receiver 418, respectively. Processor 442 may be configured to execute instructions 452 stored in memory 444 to perform the operations described herein. In some implementations, processor 442 includes or corresponds to one or more of receive processor 258, transmit processor 264, and controller 280, and memory 444 includes or corresponds to memory 282.

Memory 444 includes or is configured to store instructions 452 and information 454. Instructions 452 may include or correspond to instructions 407. Information 454 may include or correspond to information 406. Information 454 may include capability information, location information, travel information, or a combination thereof. Additionally, or alternatively, information 454 may include or indicate a location or position (e.g., latitude, longitude, elevation, etc.), position accuracy (e.g., HEPE), a dilution of precision (DOP) or a component thereof, a heading, a speed (or velocity), an altitude, a device state, a path history, a predicted path, a planned plan, an ID, a time, a steering wheel angle, acceleration, Yaw rate, brake system status, a device or vehicle size (e.g., a length, a width, a height, a weight, etc.), an event flag, or a combination thereof, as illustrative, non-limiting example.

Transmitter 446 is configured to transmit reference signals, control information and data to one or more other devices, and receiver 448 is configured to receive references signals, synchronization signals, control information and data from one or more other devices. For example, transmitter 446 may transmit signaling, control information and data to, and receiver 448 may receive signaling, control information and data from, base station 105, network entity 405, another vehicle 450, or UE 115. In some implementations, transmitter 446 and receiver 448 may be integrated in one or more transceivers. Additionally, or alternatively, transmitter 446 or receiver 448 may include or correspond to one or more components of UE 115 described with reference to FIG. 2.

In some implementations, vehicle 450 may include one or more antenna arrays. The one or more antenna arrays may be coupled to transmitter 446, receiver 448, or a communication interface. The antenna array may include multiple antenna elements configured to perform wireless communications with other devices, such as with the base station 105. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of vehicle 450. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

Non-terrestrial signal sensor 449 may include one or more global navigation satellite system (GNSS) sensors. A GNSS may include or correspond to a satellite constellation that provides positioning, navigation, and timing (PNT) services on a global or regional basis. In some implementations, non-terrestrial signal sensor 449 may include or correspond to transmitter 416, receiver 418, or a combination thereof.

In some implementations, non-terrestrial signal sensor 449 is configured to perform a measurement or generate a report, such as a GNSS sensor position report. For example, non-terrestrial signal sensor 449 may be configured to generate the report at a regular interval, such as 1 Hertz (Hz) (e.g., once per second). Additionally, or alternatively, each CNSS sensor measurement may include multiple interdependent dilution of precision (DOP) scalars, ephemeris data associated with a satellite vehicle correction, or a combination thereof. In some implementations, the DOP scalars may include a horizontal DOP (2D-HDOP), a position DOP (3D-DOP), a vertical DOP (VDOP), a time DOP (TDOP), or a combination thereof. The 2D-HDOP may be associated with latitude, longitude, or a combination thereof, the 3D-PDOP may be known as a spherical DOP, the VDOP may be associated with altitude, and the TDOP may be associated with time.

Vehicle 451 may include or correspond to vehicle 450. For example, vehicle 451 may include one or more components as described with reference to vehicle 450. Additionally, or alternatively, vehicle 451 may be configured to perform one or more operations as described with reference to vehicle 450. It is also noted that vehicle 450 may be configured to also perform one or more operations as described with reference to vehicle 451.

Vehicle 450 or 451 may include one or more components as described herein with reference to UE 115, the vehicle of FIG. 11, or the network entity of FIG. 13. In some implementations, vehicle 450 or 451 is a 5G-capable vehicle, a 6G-capable vehicle, or a combination thereof.

Network entity 405 may include a device, such as a base station, a roadside unit, a node, or another UE. Network entity 405 may be a mobile device or a stationary device. Network entity 405 may include a variety of components (such as structural, hardware components) used for carrying out one or more functions described herein. For example, these components may include one or more processors 422 (hereinafter referred to collectively as “processor 422”), and one or more memory devices 424 (hereinafter referred to collectively as “memory 424”). In some implementations, network entity 405 may include an interface (e.g., a communication interface) that includes transmitter 426, receiver 428, or a combination thereof. Processor 422 may be configured to execute instructions 430 stored in memory 424 to perform the operations described herein. In some implementations, processor 422 includes or corresponds to one or more of receive processor 238, transmit processor 220, and controller 240, and memory 424 includes or corresponds to memory 242.

Memory 424 includes or is configured to store instructions 430 and information 434. Information 434 may include or correspond to information 406 or 454. For example, network entity 405 may be configured to receive, from vehicle 450, vehicle information 490 or group information, each of which may include or indicate information 406.

Network entity 405 includes one or more transmitters 426 (hereinafter referred to collectively as “transmitter 426”), and one or more receivers 428 (hereinafter referred to collectively as “receiver 428”). Transmitter 426 is configured to transmit reference signals, control information and data to one or more other devices, and receiver 428 is configured to receive references signals, synchronization signals, control information and data from one or more other devices. For example, transmitter 426 may transmit signaling, control information and data to, and receiver 428 may receive signaling, control information and data from, base station 105, UE 115, vehicle 450, another network entity 405, or server 480. In some implementations, transmitter 426 and receiver 428 may be integrated in one or more transceivers. Additionally, or alternatively, transmitter 426 or receiver 428 may include or correspond to one or more components of base station 105 described with reference to FIG. 2.

In some implementations, network entity 405 may include one or more antenna arrays. The one or more antenna arrays may be coupled to transmitter 426, receiver 428, or a communication interface. The antenna array may include multiple antenna elements configured to perform wireless communications with other devices, such as with UE 115 or base station 105. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of network entity 405. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

Network entity 405 may include one or more components as described herein with reference to UE 115 or base station 105. In some implementations, network entity 405 is a 5G-capable network entity, a 6G-capable network entity, or a combination thereof.

Server 480 may include a variety of components (such as structural, hardware components) used for carrying out one or more functions described herein. For example, these components may include one or more processors 482 (hereinafter referred to collectively as “processor 482”), one or more memory devices 484 (hereinafter referred to collectively as “memory 484”), and one or more communication devices 475 (hereinafter referred to collectively as “communication device 475”). In some implementations, server 480 may include an interface (e.g., a communication interface) that includes communication device 475.

Processor 482 may be configured to execute instructions 486 stored in memory 484 to perform the operations described herein. In some implementations, processor 482 includes or corresponds to one or more of receive processor 238, transmit processor 220, and controller 240, and memory 484 includes or corresponds to memory 242.

Memory 384 includes or is configured to store instructions 486, map information 488, intersection information 499, group information 494, accuracy information 495, alert information 497, and one or more thresholds 477 (hereinafter referred to collectively as “threshold 477”). Map information 488 may include or indicate aspects or features of geographic area 476. Map information 488 may include or indicate roads, intersections, traffic control devices, geographic features, hazards, or a combination thereof, as illustrative, non-limiting examples. In some implementation, map information 488 may include intersection information 499. For example, map information 488 may include or indicate an intersection (e.g., 478). Additionally, or alternatively, map information 488 may include or indicate a population density, a traffic density, or a combination thereof. The population density may include or indicate a designation or a type of an arca or a region based on a concentration or distribution of a population. The designation or the type associated with population may include rural, semi-rural, urban, suburban, or city center, as illustrative, non-limiting examples. The traffic density may include or indicate a designation or a type of traffic. The designation or the type of traffic may include recurring congestion, non-recurring congestion, light, medium, heavy, gridlock, emergency, severe, serious, moderate, or minimal, as illustrative, non-limiting examples. The designation or the type of traffic may vary or change with time.

In some implementations, map information 488 and may include meta data that indicates a population density, a traffic density, that is associated with intersection 478, or a combination thereof. To illustrate, the metadata may include intersection information 499. Although described as being included in server 480, in other implementations, map information 488 may be stored in a database that remote or accessible to server 480.

Intersection information 499 may be associated with one or more intersections, such as intersection 478. For example, intersection information 499 may include or indicate information that defines or characterizes an intersection region associated with intersection 478. The intersection region may be defined to be the same or a different size or shape as intersection 478. In some implementations, intersection information 499 may indicate or define, for intersection 478, the intersection region associated with intersection 478, or a both, a size, a shape, an origin, a length, a road, a traffic control device, a geographic feature, a hazard, or a combination thereof, as illustrative, non-limiting examples. In some implementations, intersection information 499 may include or define a geo-fenced area that is associated with an intersection (e.g., 478).

Group information 494 includes or indicates one or more groups of mobile entities (which may also be referred to as on or more platoons of mobile entities). For example, group information 494 may include a first group 487 and, optionally, a second group 496. Each group 487 or 496 may include or indicate at least one entity, such as a represented entity 489 of first group 487. In some implementations, group information 494 may include or indicate, for a group, a group configuration (e.g., 491) of the group, vehicle information 490 of an entity (e.g., 489) of the group, group information 492 of the group, or a combination thereof. In some implementations, server 480 may be configured to combine multiple groups (e.g., 487 and 496) into a combined group. Additionally, or alternatively, server 480 may be configured to divide a group, such as first group 487, into two or more sub-group.

Accuracy information 495 includes or indicates an accuracy of a position of a mobile entity, such as UE 115, vehicle 450, or vehicle 451. Alert information 497 may include or indicate a collision potential between a mobile entity and an object. For example, alert information 497 may indicate a collision potential exists for vehicle 450, such as a collision potential between vehicle 450 and an object (e.g., UE 115).

Threshold 477 may include or indicate one or more values, one or more ranges, or a combination thereof. Threshold 477 may be associated with a time, a duration, a heading, a distance, or a combination thereof.

In some implementations, wireless communications system 400 implements a 5G NR network. For example, wireless communications system 400 may include multiple 5G-capable UEs 115, multiple 5G-capable vehicles 450, 451, multiple 5G capable network entities 405, or multiple 5G-capable base stations 105, such as UEs and base stations configured to operate in accordance with a 5G NR network protocol such as that defined by the 3GPP. In some other implementations, wireless communications system 400 implements a 6G network.

In some implementations, wireless communications system 400 (e.g., server 480) is configured to group one or more mobile devices, such as one or more vehicles, into a group. For example, the one or more mobile devices may be grouped based on map information 488. The group may be configured to transmit, to server 480, one or more safety messages for the group. For example, the group may transmit one or more safety message for the group to server 480 in lieu of each mobile device of the group transmitting one or more safety message for the mobile device to server 480.

In some implementations, server 480 receives a safety message, such as a BSM, from each vehicle of a plurality of vehicles. Accordingly, server 480 has knowledge of a speed, a location, a heading, or a combination thereof, for each vehicle of the plurality of vehicles. Server 480 may group one or more vehicles of the plurality of vehicles into a group. For example, the group may include or correspond to first group 487. Server 480 may receive one or more safety messages for the group based on the group being configured. In some implementations, the one or more safety messages for the group may not include or indicate a speed or heading and server 480 may use speed information or heading information for the group that is based on one or more BSM received from vehicles of the group prior to formation of the group. In some other implementations, the one or more safety messages for the group may include or indicate the speed or heading of the group to server 480 one time or semi-statically (e.g., every 5^{th} message). Although described as speed or heading information, other information or parameters may be communicated in a similar manner if such information or parameters are not expected to change significantly for the group over time.

In some implementations, server 480 may generate the group (e.g., select the one or more vehicles or a number of vehicles for the group) based on map information 488. To illustrate, server 480 may select the one or more vehicles for the group and may generate configuration information, such as configuration 491, to transmit to at least one vehicle of the group. Server 480 may select the group or generate the group (e.g., configuration 491) based on map information 488, such as whether map information 488 indicates that an area associated with the one or more vehicles is rural, semi-urban, or urban. Additionally, or alternatively, server 480 may select the group or generate the group (e.g., configuration 491) based on a population density, a traffic density, or a combination thereof, indicated by map information 488.

In some implementations, server 480 may configure the group such that one vehicle of the group is designated as a leader of the group. The leader of a group may be an initial vehicle of the group in a direction of travel, a last vehicle of the group in a direction of travel, or another vehicle in the group other than the initial vehicle or the last vehicle. The leader of the group may be configured to transmit one or more safety messages to server 480. For example, the leader may transmit the one or more safety messages on behalf of the group such that other vehicles of the group do not need to transmit safety messages to server 480. In some such implementations, the designation of a leader and the configuration of the leader transmitting one or more safety message on behalf of the group (such that other vehicles of the group do not need to transmit safety messages to server 480) may be performed based on map information 488 that indicates that an area associated with the one or more vehicles is rural or semi-urban.

In some implementations, the one or more safety messages transmitted by the leader may include BSM information of the leader, and may not include BSM information of another vehicle of the group. In some other implementations, the one or more safety messages transmitted by the leader may include information associated with another vehicle of the group. For example, the one or more safety messages transmitted by the leader may include safety information (e.g., BSM information) of the other vehicle, CPM information from the other, distance or position information associated with the other vehicle, or a combination thereof. Additionally, the one or more safety message may include safety information of the leader. To illustrate, the one or more safety messages transmitted by the leader may include BSM information of the leader and BSM information of at least one other vehicle of the group other than the leader.

In some implementations, server 480 may configure the group based on a pattern, such as a preconfigured pattern. For example, the pattern may include or indicate that each vehicle of the group is configured to transmit BSM information of the vehicle in a round-robin fashion-e.g., one after the other. As another example, the pattern may include or indicate that an initial vehicle and a last vehicle of the group alternat transmitting its BSM information. In some such implementation, a leader of the group may or may not be designated by server 480. In some implementations, server 480 may select the pattern based on map information 488 that indicates that an area associated with the one or more vehicles is urban.

By configuring the group to transmit one or more safety messages for the group, an amount of OTA resources may be reduced as compared to each vehicle of the group transmitting its own safety messages. Additionally, or alternatively, the one or more safety messages transmitted by the group may not negatively impact VRU safety—e.g., server 480 acquires sufficient information based on the one or more messages from the group to identify a potential collision. Additionally, configuring the group to transmit one or more safety messages for the group, wireless communications system 400 (e.g., server 480) may not have to a perform collision potential calculation for every individual vehicle in the group. Stated differently, wireless communications system 400 (e.g., server 480) may perform collision potential for the group, which enable scaling of performing collision potential calculations.

In some implementations, wireless communications system 400 (e.g., server 480) is configured to determine a position or interaction of the group with respect to intersection 478 or other geo-fenced zone. For example, server 480 may determine an entry (e.g., a time of entry) of the group into intersection, an exit (e.g., a time of exit) of the group from intersection 478, or a combination thereof. To illustrate, server may determine the entry or the exit based on map information 488, intersection information 499, accuracy information, or a combination thereof. Server 480 may use the entry or the exit of the group to identify or determine a potential collision. To determine the entry or the exit, server 480 may use information included in or indicated by one or more safety messages for the group.

In some implementations, server 480 may use safety information from a single member of the group to determine the entry of the group or the exit of the group. The safety information may include a speed, a heading, a distance or offset between two vehicle of the group, or a combination thereof, as illustrative, non-limiting examples. The safety information may be based on or included in a safety message received from the leader of the group, such as safety information (e.g., speed or heading) that is received once or semi-statically, as illustrative, non-limiting examples. As an illustrative example, server 480 may use a speed and a heading reported by one vehicle of the group to determine a time of entry into intersection 478 (e.g., a geo-fenced zone). As another example, server 480 may calculate a time of exit based on a speed, a distance between two vehicles of the group (e.g., an initial vehicle and a last vehicle), a position of a reporting vehicle (e.g., the leader), or a combination thereof. As an illustrative, non-limiting example, server 480 may determine the entry time of the group into a geo-fenced zone (E.g., intersection 478) based on safety information received from the leader of the group that is the initial vehicle, and may calculate the exit time based on a length of the group and a relative speed of another vehicle (e.g., the last vehicle of the group) with respect to the leader.

In some implementations, server 480 may determine a time of entry of the group into intersection 478 (e.g., a geo-fenced zone) based on a safety message from an initial vehicle of the group. Additionally, or alternatively, server 480 may determine a time of exit of the group from intersection 478 (e.g., a geo-fenced zone) based on a safety message from a last vehicle of the group.

In some implementations, wireless communications system 400 (e.g., server 480) is configured to provide an alert, such as alert message 493, to the group. For example, server 480 may determine that one or more vehicles of the group have a collision potential. Additionally, or alternatively, server 480 may determine that one or more vehicles of the group do not have a collision potential. In some implementations, server 480 may determine whether or not a collision potential exists (with another object within a zone) based on an entry time of the group into or an exit time of the group from the zone, such as a geo-fenced zone (e.g., intersection 478).

In some implementations, server 480 may determine a collision potential for the group and may transmit the alert to at least one member of the group. For example, server 480 may transmit the alert to the leader and the leader may notify one or more other vehicles in the group of the collision potential. To illustrate, the leader may use a sidelink communication to indicate to at least one other vehicle of the collision potential. As another example, server 480 may transmit the alert to each vehicle of the group.

In some implementations, server 480 may transmit the alert to one or more vehicles that have a collision potential. For example, server 480 may determine that the last vehicle of the group has the collision potential and may only transmit the alert to the last vehicle. Additionally, or alternatively, server 480 may transmit the alert to at least one vehicle that may be impacted due to a speed update likely to be performed by the vehicle having the position potential. For example, server may determine that the second to last vehicle has a collision potential and may transmit an alert to the last vehicle to notify the last vehicle that the second to last vehicle has the collision potential and is likely to change (e.g., reduce speed).

In some implementations, wireless communications system 400 (e.g., server 480) is configured to combine groups or divide a group. For example, server 480 may be configured to sub-divide a group into multiple sub-groups. Server 480 may sub-divide the group based on map information 488. To illustrate, server 480 may divide the group into a number of smaller groups (e.g., sub-groups) based on map information 488 indicating that an arca of the group is semi-rural. In some implementations, one sub-group may be designated as a leader and may transmit safety messages on behalf of multiple sub-groups. In some other implementations, two or more sub-groups may transmit safety messages to server 480 based on a pattern, such as a pattern (e.g., round robin, alternating, etc.) indicated by server 480. In some other implementations, each sub-group may be designated a leader of the sub-group and the leader of the sub-group may transmit one or more safety messages on behalf of the sub-group to server 480. In some such implementations, dividing the group into multiple sub-groups may increase the granularity of safety messages being reported by each smaller group for safety purposes, while not significantly increasing the overall amount of safety message reporting (e.g., without significantly increasing a safety message overhead). Additionally, or alternatively, dividing the group into multiple sub-groups may account for situations or circumstances in which each vehicle of the group do not have the same, a uniform, or a substantially uniform speed or heading.

In some implementations, server 480 may be configured to combine multiple groups into a combined group. The combined group may be designated with a leader vehicle which is configured to transmit one or more safety messages on behalf of the combined group. Server 480 may combine groups based on map information 488. To illustrate, server 480 may combine groups, such as first group 487 and second group 496, based on map information 488 indicating that an area of the group is rural. In such rural situations, a collision potential is low and combining the groups to form a combined group may reduce an amount of safety message transmission.

In some implementation, one or more mobile entities may be configured to operate with a positioning system, such as a GNSS. For example, the one or more mobile entities may include UE 115, vehicle 450, or vehicle 451. Each mobile entity of the one or more mobile entities may include a non-terrestrial signal sensor, such as non-terrestrial signal sensor 449. The non-terrestrial signal sensor may be configured to perform a measurement or generate a report, such as a GNSS sensor position report. For example, the non-terrestrial signal sensor may be configured to generate the report at a regular interval, such as 1 Hz (e.g., once per second). Additionally, or alternatively, each GNSS sensor measurement may include multiple interdependent DOP scalars, ephemeris data associated with a satellite vehicle correction, or a combination thereof. In some implementations, the DOP scalars may include a 2D-HDOP, a 3D-DOP, a VDOP, a TDOP, or a combination thereof.

In some implementations, a mobile entity that includes the non-terrestrial signal sensor may be configured to provide or indicate, to another device or entity, one or more DOP scalars. Additionally, or alternatively, the mobile entity may determine a level of accuracy based on the one or more DOP scalars. For example, the mobile entity may determine whether the one or more DOP scalars are associated with a high level of accuracy or a low level of accuracy. In some implementations, the mobile entity may determine the level of accuracy based on 2D-HDOP, 3D-DOP, or a combination thereof, as illustrative, non-limiting examples.

As previously mentioned, the detection and tracking of a VRU (e.g., a pedestrian, a bicyclist, a motorcyclist, scooter rider, a road worker, a wheelchair user, or a skateboard rider) is paramount for road safety. There are systems, currently, that can reliability detect, track, and report the location, position, and/or speed of VRUs, which are located within a FOV of a camera (e.g., an image sensor) of an RSU. Within a FOV of a camera of an RSU is an ROI.

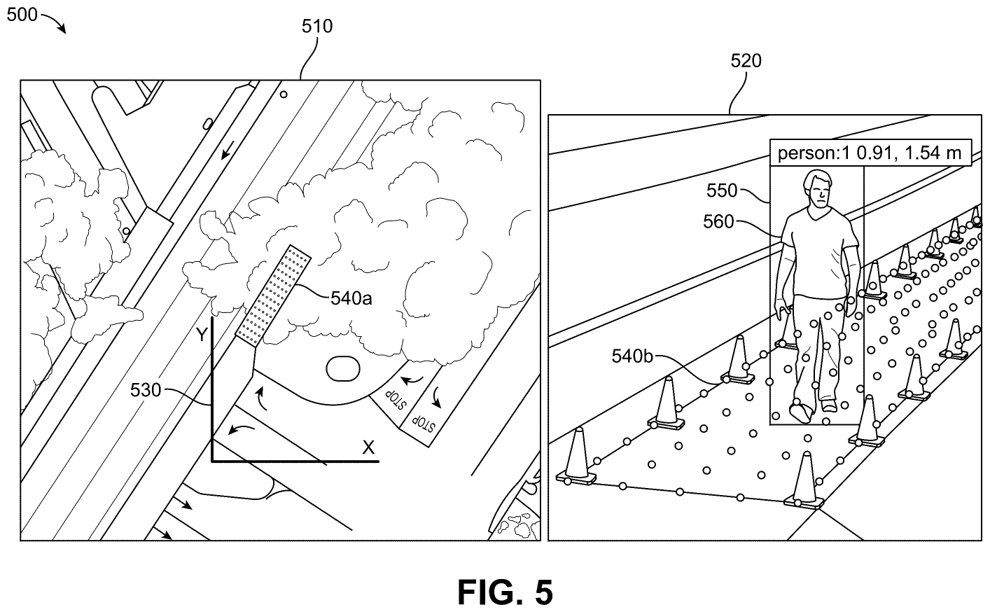

FIG. 5 shows examples of a FOV and an ROI of a camera of an RSU. In particular, FIG. 5 is a diagram illustrating examples 500 of images 510, 520 showing an ROI 540a, 540b and a FOV (e.g., as shown in image 520) of a camera associated with a device. In FIG. 5, the image 510 shows a bird's eye view (BEV) of a scene. The image 510 includes a pair of orthogonal axes 530, including an x-axis and a y-axis. The origin of the axes 530 denotes the location of a camera of an RSU. The image 510 is also shown to include an ROI 540a of the camera of the RSU. The ROI 540a is shown to be located along a length of a sidewalk in the scene.

Image 520 of FIG. 5 shows a FOV of the camera of the RSU. The FOV is shown to include the ROI 540b of the camera of the RSU. As such, the size of the area of the ROI 540b is smaller than the size of area of the FOV of the camera of the RSU. The ROI 540b is shown to be located along the length of the sidewalk in the FOV. A VRU 560 (e.g., a pedestrian) is shown to be walking along the sidewalk within the ROI 540b of the FOV of the camera of the RSU. The camera of the RSU can detect and track the movement of the VRU 560 using object detection. As a result of the detection, the camera of the RSU can create a bounding box 550 surrounding the detected VRU 560.

In one or more aspects, an ROI of a camera of an RSU is located within a FOV of a camera of an RSU (e.g., as is shown in FIG. 5). Identifying (and maintaining) an ROI requires that the installation, orientation, and hardware specifications of the camera of the RSU remain fixed. The camera of the RSU periodically requires calibration of the FOV because the orientation of the camera can change, such as when a camera is moved due to strong winds caused by a storm. Movement of the camera without a subsequent re-calibration of the camera can cause the FOV or ROI of the camera to change. The calibration of the camera can be performed by manual or automatic methods. A well calibrated camera of an RSU is a highly integral aspect, which determines the reliability of the detection of a VRU and, by extension, the level of safety posed to the VRU.

A V2X-enabled VRU device (e.g., such as a smart phone associated with a VRU, such as a pedestrian) may transmit standardized pedestrian safety messages (PSMs). The PSMs can be transmitted periodically. PSMs may include information obtained from sensors associated with the V2X-enabled VRU device or the associated VRU. The PSMs may be transmitted by the V2X-enabled VRU device via wireless links to other VRUs, vehicles, pedestrians, and/or traffic infrastructure. Sharing this information allows for situational awareness of the location and travel of a VRU associated with the V2X-enabled VRU device to help reduce collisions with the VRU and other vehicles and entities.

As noted previously, a camera of a V2X-enabled RSU can detect a VRU located within the FOV or ROI of the V2X-enabled RSU. Based on detection of the VRU, the V2X-enabled RSU may generate and transmit PSMs that include information about the location of the detected VRU for safety purposes.

In some cases, the PSMs can be transmitted periodically. For instance, one PSM may be transmitted very one second. Such periodic transmission of the PSMs can cause a V2X-enabled VRU device associated with a VRU (e.g., such as a pedestrian) to require additional battery resources as well as an increased computational load on the application processor running on the smart phone. The transmissions of the PSMs can require users (e.g., a VRU, such as a pedestrian, associated with the smart phone) to allow permissions to share real-time location information, which can increase the rate by which a smart phone's battery gets consumed. There may be privacy or security concerns with sharing position information of the user. For instance, a user may not be comfortable sharing the accurate position information (e.g., to a third party cloud service).

In another example, a VRU (e.g., such as a pedestrian or bicyclist) may be carrying more than one V2X-enabled VRU device (e.g., a bicyclist is carrying a V2X-enabled smart phone and a V2X-enabled smart watch). In such an example, transmission of PSMs from both of these V2X-enabled VRU devices can be redundant or unnecessary. It some cases, the VRU (e.g., pedestrian or bicyclist) can turn “off” the V2X-enabled safety system (e.g., which generates and transmits PSMs) on one of the V2X-enabled VRU devices (e.g., the smart phone) to conserve the battery of that V2X-enabled VRU device (e.g., the smart phone). However, in turning off one of the V2X-enabled safety systems, the VRU (e.g., pedestrian or bicyclist) may not always have possession of the other V2X-enabled VRU device (e.g., the VRU may have left the smart watch at home), in which case the VRU can have higher chances of having a collision.

In yet another example, a VRU (e.g., such as a pedestrian or bicyclist) may be traveling inside of a tunnel or through an area of poor GNSS coverage. In such an example, the position estimates generated by the V2X-enabled VRU device (e.g., associated with the VRU) for itself may have errors due to the poor GNSS coverage. SAE has provisions, such those in SAE J2735[5], where positional parameters encoded in PSMs may be used to triangulate the position of a VRU. However, if the position estimates are highly inaccurate, an accurate position of the VRU cannot be determined via the triangulation. Incorrect estimates in periodic PSMs can, thus, lead to false alarms and inefficiencies.

Some applications (e.g., available in Google PlayStore) can generate false position reports of a V2X-enabled VRU device. Such applications can be used by a malicious user or an attacker such that the reported position in a PSM is not an accurate position of the VRU. Generating and transmitting false position reports (e.g., within PSMs) can increase the rate of false alarms and misdetections that can affect the VRU safety. Therefore, improved systems and techniques for transmission of PSMs that can solve for the above-mentioned issues while conserving the battery of a V2X-enabled VRU device can be useful.

In one or more aspects, the systems and techniques described provide battery enhancements for a V2X-enabled VRU device. Various aspects relate generally to wireless communications. Some aspects more specifically relate to systems and techniques that provide solutions that modify the transmissions of PSMs by a V2X-enabled VRU device to conserve the battery of the V2X-enabled VRU device. In one or more examples, an RSU can detect and track a VRU. Based on this detection, the RSU can be triggered to transmit, to the VRU, a message mute request. The message mute request can include information that may include, but is not limited to, coordinates of an ROI of the RSU, the coordinates of the RSU itself, a timestamp for transmission of the message mute request, security certificates to be used for communications with the RSU, a timer value indicating a duration of time for stopping transmission of the PSMs, a mute bitmask indicating stopping one or more particular transmissions of the PSMs, and/or a device ID for the V2X-enabled VRU device. The VRU can validate this information within the message mute request, and can accept the message mute request by modifying its transmissions of the PSMs according to the information in the message mute request. The RSU may periodically (or aperiodically) track the movement of the VRU. If the RSU determines that the VRU is located within a threshold distance from an edge of an ROI (e.g., appearing that the VRU is leaving the ROI), the VRU can resume transmission of the PSMs.

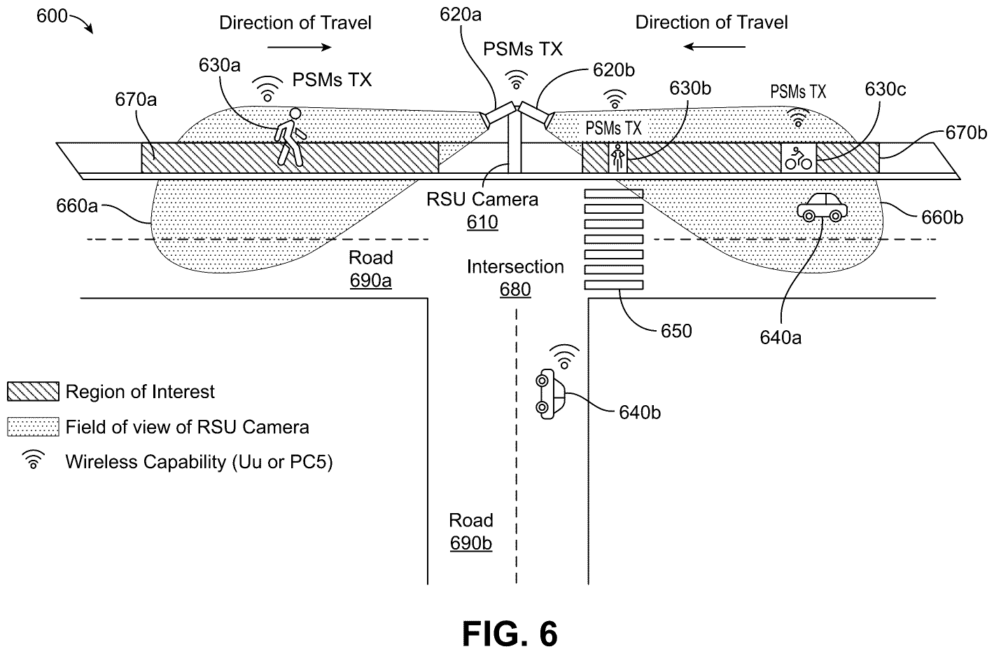

FIG. 6 show an example system for conserving a battery of a VRU. In particular, FIG. 6 is a diagram illustrating an example of a system 600 for battery enhancements for a V2X-enabled VRU device. In FIG. 6, the system 600 is shown to include an RSU 610, which includes two cameras 620a, 620b. The RSU 610 is located at a T-shaped intersection 680, where two roads 690a, 690b cross each other to form the T-shaped intersection 680. The RSU 610 is configured to transmit PSMs based on detections made using cameras 620a and 620b (e.g., by analyzing or processing images captured using the cameras 620a and 620b), respectively.

The system 600 of FIG. 6 is also shown to include a plurality of VRUs 630a, 630b, 630c. VRU 630a is shown to be in the form of a pedestrian that is walking along a sidewalk that runs along the road 690a. The pedestrian is carrying a V2X-enabled device (e.g., a smart phone) that can transmit PSMs. VRU 630b is shown to be in the form of a bicyclist that is riding along a crosswalk 650 that crosses the road 690a. The VRU 630b is carrying a V2X-enabled device (e.g., a smart phone or other device) that can transmit PSMs. VRU 630c is shown to be in the form of a bicyclist that is riding along a sidewalk that runs along the road 690a. The VRU 630c is carrying a V2X-enabled device (e.g., a smart phone) that can transmit PSMs.

In FIG. 6, the system 600 is shown to also include two vehicles 640a, 640b. Vehicle 640a is shown to be driving along road 690b. Vehicle 640a is not V2X-enabled and, as such, cannot receive PSMs transmitted from the VRUs 630a, 630b, 630c. Vehicle 640b is shown to be driving along road 690a. Vehicle 640b is V2X-enabled and, thus, is able to receive PSMs transmitted from the VRUs 630a, 630b, 630c.

In one or more examples, the system 600 may include more or less number of RSUs 610, VRUs 630a, 630b, 630c, and/or vehicles 640a, 640b than as shown in FIG. 6. In some examples, the system 600 may include different types of VRUs 630a, 630b, 630c (e.g., motorcyclists, etc.) than the types of VRUs that are shown in FIG. 6.

In FIG. 6, an FOV 660a and an ROI 670a of the camera 620a of the RSU 610 is shown. FIG. 6 also shows an FOV 660b and an ROI 670b of the camera 620b of the RSU 610. The VRU 630a is shown to be located within the ROI 670a and the FOV 660a of the camera 620a of the RSU 610. FIG. 6 also shows the VRUs 630b, 630c to be located within the ROI 670b and the FOV 660b of the camera 620b of the RSU 610.

In one or more aspects, as similarly shown in FIG. 6, a VRU (e.g., a pedestrian) may be travelling on a sidewalk (or within a tunnel). The VRU may be periodically transmitting PSMs. The VRU may also be detected (and tracked) in the FOV and/or ROI of a camera of an RSU (e.g., which may be located at the intersection of roads). The systems and techniques provide signaling and methods by which the transmissions of PSMs from a V2X-enabled VRU device (e.g., associated with a VRU, such as a pedestrian) can be muted (or reduced) such that an RSU may transmit PSMs on behalf of the VRU, if the movement of the VRU is within the FOV and/or ROI of the camera of the RSU.

In one or more examples, if a camera of an RSU detects a VRU inside of a FOV and/or an ROI of the camera of the RSU, this detection can trigger the RSU to transmit a message mute request to the VRU. The message mute request may include information including parameters. In one or more examples, the parameters may include, but are not limited to, GNSS coordinates of the ROI of the camera of the RSU (e.g., four vertices or four GNSS coordinates of a ROI polygon, which may be Cartesian coordinates and/or latitude/longitude coordinates), GNSS coordinates of the location of the RSU (e.g., the location of where the camera of the RSU is mounted on the pole of the RSU), a coordinated universal time (UTC) timestamp (e.g., a time reference for all of the geolocated road actors, which may include VRUs, vehicle, and traffic infrastructure), security certificates for communications (e.g., may reuse Uu or PC5 security signatures), an optional timer value (e.g., which may be in seconds and may indicate the duration for which a VRU may stop transmission of the PSMs), a mute bitmask (e.g., including bits indicating which PSM transmissions may be muted, for example every other PSM transmission may be muted), and/or a VRU ID (e.g., an RSU may keep a record of VRUs that are detected and tracked within the FOV of a camera(s) of the RSU and may assign a unique ID to each of the VRUs). In one or more examples, when an RSU detects multiple VRUs in the FOV and/or ROI, the RSU may create a bitmask for each unique VRU ID (e.g., to toggle the transmissions of PSMs by the multiple detected VRUs, such that only one of the VRUs is transmitting PSMs at a time). In some examples, a corresponding message mute request (e.g., which may include a bitmask) and message resume request may be sent uniquely for each VRU ID.

After a VRU receives a message mute request from an RSU, the VRU may determine (e.g., verify) whether the VRU is actually located within the ROI coordinates sent in the message mute request from the RSU. In one or more examples, if the VRU determines that the VRU is not located within the ROI coordinates, the VRU may ignore the message mute request from the RSU, or the VRU may transmit a rejection message to the RSU. The rejection message indicates that the VRU is rejecting the message mute request from the RSU.

If the VRU determines that the VRU is indeed located within the ROI coordinates, the VRU may modify transmissions of the PSMs according to the information within the message mute request. In one or more examples, the VRU may stop transmissions of PSMs, stop transmissions of the PSMs for the duration of the timer value, or transmit PSMs according to the bitmask. In some examples, a V2X-enabled VRU device may perform certificate or security checks prior to taking any action (e.g., prior to adhering to the message mute request or not). If a camera of an RSU detects multiple VRUs, the RSU may create different bitmasks for each unique VRU ID. Each V2X-enabled VRU device may then follow the mute pattern dedicated to each specific V2X-enabled VRU device. Alternatively, a VRU may ignore the message mute request and send a rejection message back to RSU if the message mute request is declined by the VRU.

In one or more examples, an RSU can periodically check (and/or track) the movement of the VRU. If the VRU's heading or position changes drastically, the RSU can send (e.g., transmit) a message resume request. For example, if the RSU detects that the VRU is approaching the edges of the ROI (e.g., edges of the ROI polygon) or if the VRU's heading or speed changes drastically, the RSU may be triggered to send a message resume request to the VRU. A message resume request may also be sent by the RSU, if the timer value (e.g., within the message mute request) has expired. In some examples, based on detection of the RSU that the VRU is approaching the edges of the ROI (e.g., edges of the ROI polygon) or if the VRU's heading or speed changes drastically, the RSU may be triggered to send an updated message mute request, which includes updated parameters (e.g., an updated bitmask to increase the frequency of the transmission of the PSMs).

In some examples, if a message resume request is received by the VRU prior to the expiration of the timer value (e.g., within the message mute request), the VRU may resume normal (e.g., according to the standards) transmissions of PSMs. If the VRU does not receive a message resume request from the RSU, the VRU may wait to resume transmissions of PSMs until the timer value has expired. In one or more examples, the V2X-enabled VRU device may have a feature to automatically determine (e.g., check) whether the VRU's current location is outside of the ROI (e.g., the ROI polygon). If the VRU determines that its location is outside of the ROI and the VRU has not received a message resume request from the RSU before the expiration of the timer value, the VRU may resume normal (e.g., according to the standards) transmissions of PSMs. In some examples, a V2X-enabled VRU device may override a message mute request, if sensors onboard (e.g., implemented within) the V2X-enabled VRU device detect any sudden changes in the speed or heading of the VRU.

In one or more aspects, during operation of the systems and techniques for battery enhancements for a V2X-enabled VRU device, a first device (e.g., an RSU, such as RSU 610 of FIG. 6) may detect a second device (e.g., a V2X-enabled VRU device associated with a VRU, such as a pedestrian, for example pedestrian 630a of FIG. 6)) within a region of interest of a scene, which is within a field of view of the first device (e.g., within a field of view of at least one camera of the first device). Based on detecting the second device within the region of interest of the scene, the first device may transmit a message mute request to the second device.

In one or more examples, the message mute request may request the second device to modify transmission of messages by stopping transmission of the messages or reducing a frequency of transmission of the messages. In some cases, the first device may transmit a message resume request to the second device. In one or more examples the message resume request may request the second device to resume transmission of the messages or increase the frequency of transmission of the messages. In some aspects, the message mute request indicates a time duration for the modifying the transmission of the messages by the second device. For instance, after the time duration ends, the second device may resume transmission of the messages or increase the frequency of transmission of the messages (e.g., to a frequency at which the second device transmitted messages prior to the message mute request).

In one or more examples, the first device may transmit messages (e.g., periodic messages) for the second device in response to transmitting the message mute request. In some examples, the first device may cease transmission of the messages for the second device in response to transmitting the message resume request.

In some examples, the message mute request may include one or more parameters. In one or more examples, the one or more parameters may include coordinates (e.g., cartesian coordinates or latitude and longitude coordinates) of a region of interest (e.g., a region of interest polygon) within the field of view of the first device, coordinates of a location of the first device, a timestamp indicating a time of transmission by the first device of the message mute request, one or more safety certificates for communications, a timer value indicating a duration of time (e.g., in seconds) for modifying the transmission of the messages, a mute bitmask indicating stopping one or more transmissions of the messages, and/or a device identification associated with the second device.

In one or more examples, the message mute request may include a mute bitmask including a plurality of bits, where each bit of the plurality of bits may indicate a particular message transmission the second device is not to transmit. In some examples, the first device may receive a rejection message from the second device indicating rejection of the message mute request by the second device.

In one or more examples, the message resume request may be transmitted based on determining a timer value has expired, detecting movement of the second device by greater than a threshold amount, and/or detecting the second device leaving a region of interest within the field of view of the first device. In some examples, detecting the movement of the second device by greater than the threshold amount may include detecting a heading and/or speed of the second device changes by more than the threshold amount. In one or more examples, the first device may detect the second device is leaving the region of interest based on determining the second device is within a threshold distance from an edge of the region of interest.

In some examples, the messages may be V2X messages. In one or more examples, the V2X messages may include pedestrian safety messages (PSMs). In some examples, the first device may be an RSU. In one or more examples, the second device may be associated with a VRU. In some examples, the request to modify transmission of the messages may include a request to stop transmission of the messages or to reduce a frequency of transmission of the messages.

In one or more aspects, during operation of the systems and techniques for battery enhancements for a V2X-enabled VRU device, a first device (e.g., a V2X-enabled VRU device associated with a VRU, such as a pedestrian, for example pedestrian 630a of FIG. 6) may receive, from a second device (e.g., an RSU, such as RSU 610 of FIG. 6), a message mute request based on the first device being within a region of interest of a scene. The region of interest being is within a field of view of the second device (e.g., within a field of view of at least one camera of the second device). In one or more examples, the message mute request may request the first device to modify transmission of messages (e.g., by stopping transmission of the messages or reducing a frequency of transmission of the messages). Based on the message mute request, the first device may determine whether to modify transmission of the messages. In some cases, the first device may receive, from the second device, a message resume request. In one or more examples, the message resume request may request the first device to resume transmission of the messages or increase the frequency of transmission of the messages. In some cases, the message mute request indicates a time duration for the modifying the transmission of the messages by the second device. For instance, after the time duration ends, the first device may resume transmission of the messages or increase the frequency of transmission of the messages (e.g., to a frequency at which the first device transmitted messages prior to the message mute request). Based on the message resume request or the time duration, the first device may resume transmission of the messages or increase the frequency of transmission of the messages.

In one or more examples, the first device may modify transmission of the messages based on the message mute request. In some examples, modifying transmission of the messages may include stopping transmission of the messages or reducing a frequency of transmission of the messages. In one or more examples, the first device may determine to reject the message mute request, and transmit, to the second device, a rejection message based on determining to reject the message mute request. In some examples, the first device may determine to reject the message mute request based on a security check.

In some examples, the message mute request may include one or more parameters. In one or more examples, the one or more parameters may include coordinates of a region of interest within the field of view of the second device, coordinates of a location of the second device, a timestamp indicating a time of transmission by the second device of the message mute request, one or more safety certificates for communications, a timer value indicating a duration of time for modifying the transmission of the messages, a mute bitmask indicating stopping one or more transmissions of the messages, and/or a device identification associated with the first device.

In one or more examples, the message mute request may include a mute bitmask including a plurality of bits, where each bit of the plurality of bits may indicate a particular message transmission the first device is not to transmit. In some examples, the message resume request may be based on a timer value expiring, movement of the first device by greater than a threshold amount, and/or the first device leaving a region of interest within the field of view of the first device.

In some examples, the messages may be V2X messages. In one or more examples, the V2X messages may include PSMs. In some examples, the first device may be associated with a VRU. In one or more examples, the second device may be an RSU.

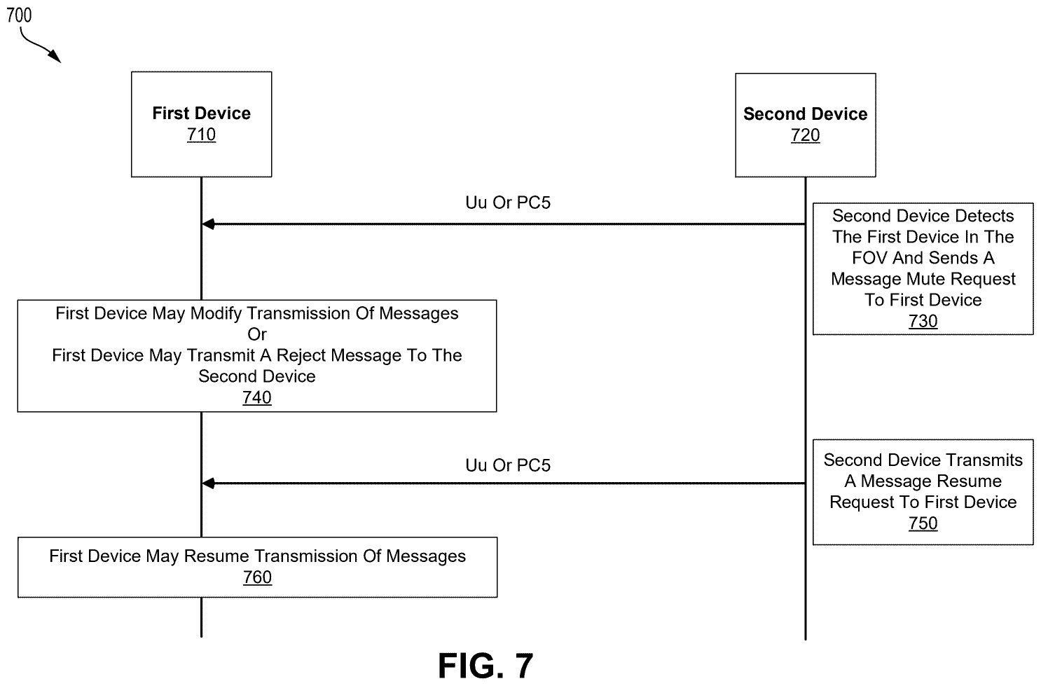

FIG. 7 shows an example of signaling 700 for the message exchange between a first device (e.g., a V2X-enabled VRU device associated with a VRU) and a second device (e.g., an RSU). For example, the signaling 700 can provide battery enhancements for a V2X-enabled VRU device. FIG. 7 shows a first device 710, which may be a V2X-enabled VRU device associated with a VRU, such as a pedestrian, for example pedestrian 630a of FIG. 6. FIG. 7 also shows a second device 720, which may be an RSU, such as RSU 610 of FIG. 6.

During operation of the signaling 700, at step 730, the second device 720 may detect the first device 710 within a field of view (FOV) (and/or an ROI) of the second device 720. The detection of the first device 710 within the FOV of the second device 720 can trigger the second device 720 to send (e.g., transmit) a message mute request to the first device 710. The message mute request may be transmitted from the second device 720 to the first device 710 via a Uu or PC5 communications. The message mute request may request the first device 710 to modify transmission of messages (e.g., V2X messages, such as PSMs).

After receiving the message mute request from the second device 720, at step 740, the first device 710 may modify transmissions of the message (e.g., PSMs), or the first device 710 may transmit a rejection message to the second device 720. If the first device 710 determines to modify transmission of the messages, the first device 710 may modify the transmissions of the messages based on (e.g., according to) the message mute request. In one or more examples, the message mute request may specify that the modifying of the transmissions of the messages may involve stopping transmissions of the messages or reducing a frequency of the transmissions of the messages.

In one or more examples, the first device 710 may determine to reject the message mute request based on a security check (e.g., of the security certificates within the message mute request). The rejection message can indicate a rejection of the message mute request by the first device 710. The rejection message may be transmitted from the first device 710 to the second device 720 via a Uu or PC5 communications.

At step 750, the second device 720 may transmit a message resume request to the first device 710. The message resume request can request the first device 710 to resume transmissions of the messages. In one or more examples, the message resume request can be transmitted based on the expiration of the timer value (e.g., within the message mute request), a detection of movement of the first device 710 being greater than a threshold amount (e.g., a threshold distance in meters), and/or a detection of the first device 710 leaving the ROI of the second device 720. In some examples, the detection of the movement of the first device 710 being greater than a threshold amount can include detecting a heading and/or speed of the first device 710 changing more than a threshold amount (e.g., in degrees and/or in miles per hour). The detection of the first device 710 leaving the ROI of the second device 720 can be based on determining that the first device 710 is within a threshold distance (e.g., in meters) from an edge of the ROI (e.g., the ROI polygon). The message resume request may be transmitted from the second device 720 to the first device 710 via a Uu or PC5 communications. After receiving the message resume request from the second device 720, at step 760, the first device 710 may resume transmissions of the messages.

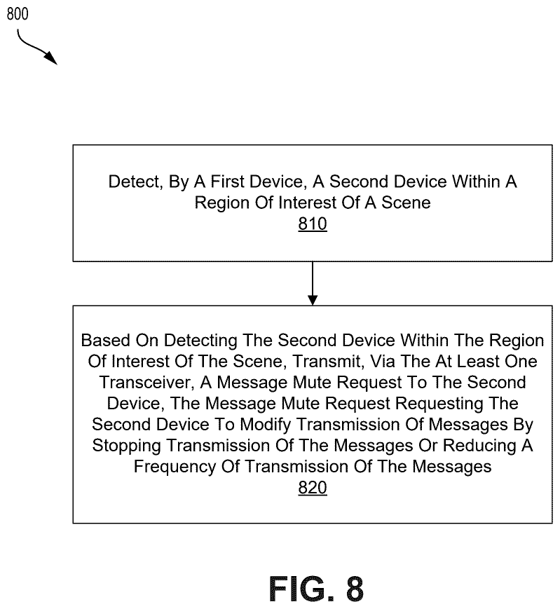

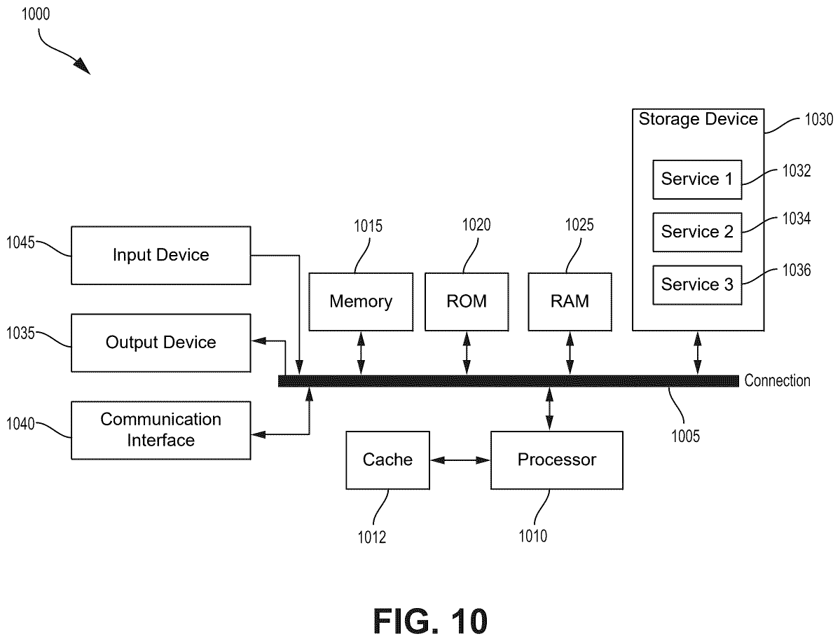

FIG. 8 is a flow chart illustrating an example of a process 800 for battery enhancements for a V2X-enabled VRU device. The process 800 can be performed by a first device (e.g., RSU 610 of FIG. 6, second device 720 of FIG. 7, and/or a computing device or computing system 1000 of FIG. 10) or by a component or system (e.g., a chipset, one or more processors central processing units (CPUs), digital signal processors (DSPs), graphics processing units (GPUs), any combination thereof, and/or other type of processor(s), or other component or system) of the first device. The operations of the process 800 may be implemented as software components that are executed and run on one or more processors (e.g., processor 1010 of FIG. 10 or other processor(s)). Further, the transmission and reception of signals by the first device in the process 800 may be enabled, for example, by one or more antennas and/or one or more transceivers (e.g., wireless transceiver(s)).

At block 810, the first device (or component thereof, such as at least one processor) can detect a second device within region of interest of a scene. For instance, the second device can be a V2X-enabled VRU device associated with a VRU (e.g., a V2X-enabled VRU device of VRU 630a, 630b, 630c of FIG. 6, first device 710 of FIG. 7, etc.). In some cases, the region of interest is within a field of view of the first device (e.g., a field of view of a camera or multiple cameras of the first device). In some aspects, the first device (or component thereof, such as at least one processor) can detect the second device within the region of interest based on one or more images captured by the first device. For example, the first device (or component thereof, such as at least one processor) can detect the region of interest in the one or more images captured by a camera of the first device, such as using one or more image processing techniques (e.g., object detection, object classification, semantic or instance segmentation, any combination thereof, and/or other image processing technique). The image processing techniques can be performed using one or more computer vision algorithms, using one or more machine learning systems (e.g., one or more neural network models, or using other algorithms or systems).

At block 820, the first device (or component thereof, such as at least one transceiver, the at least one processor via the at least one transceiver, etc.) can transmit a message mute request to the second device based on detecting the second device within the region of interest of the scene. The message mute request requests the second device to modify transmission of messages (e.g., vehicle-to-everything (V2X) messages, such as pedestrian safety messages (PSMs) or other type of V2X messages), such as by stopping transmission of the messages or reducing a frequency of transmission of the messages. For example, according to some aspects, the message mute request includes a request to stop the transmission of the messages or to reduce the frequency of transmission of the messages. In some cases, the message mute request includes a mute bitmask including a plurality of bits, where each bit of the plurality of bits indicates a particular message transmission the second device is not to transmit.

In some cases, the message mute request includes one or more parameters. The one or more parameters can include coordinates of the region of interest (e.g., within the field of view of the first device), coordinates of a location of the first device, a timestamp indicating a time of transmission by the first device of the message mute request, one or more safety certificates for communications, a timer value indicating a duration of time for modifying the transmission of the messages, a mute bitmask indicating stopping one or more transmissions of the messages, a device identification associated with the second device, any combination thereof, and/or other parameters.

In some cases, the message mute request indicates a time duration for the modifying the transmission of the messages by the second device. For example, according to some aspects, upon expiration of the time duration, the second device can resume transmission of the messages or increase the frequency of transmission of the messages (e.g., to a frequency at which the second device transmitted messages prior to the message mute request).

In some aspects, the first device (or component thereof, such as the at least one transceiver, the at least one processor via the at least one transceiver, etc.) can transmit a message resume request to the second device. The message resume request requests the second device to resume transmission of the messages or increase the frequency of transmission of the messages. In some cases, the message resume request is transmitted based on determining a timer value has expired, detecting movement of the second device by greater than a threshold amount, detecting the second device leaving the region of interest (e.g., within the field of view of the first device), any combination thereof, and/or based on other factors or triggers. For instance, the first device (or component thereof, such as the at least one processor) can detect the movement of the second device by greater than the threshold amount. For instance, the first device can detect at least one of a heading or speed of the second device changes by more than the threshold amount. In some cases, the first device (or component thereof, such as the at least one processor) can detect the second device is leaving the region of interest (e.g., based on determining the second device is within a threshold distance from an edge of the region of interest).

In some aspects, the first device (or component thereof, such as the at least one transceiver, the at least one processor via the at least one transceiver, etc.) can transmit messages (e.g., V2X messages, such as pedestrian safety messages (PSMs) or other type of V2X messages) for the second device in response to transmitting the message mute request. In some cases, the first device (or component thereof, such as the at least one processor) can cease transmission of the messages for the second device in response to transmitting the message resume request or in response to expiration of the time duration indicated in the message mute request.

In some aspects, the first device (or component thereof, such as the at least one transceiver, the at least one processor via the at least one transceiver, etc.) can receive a rejection message from the second device. The rejection message indicates a rejection of the message mute request by the second device. For example, as described herein, the second device can determine to reject the message mute request and can transmit, to the first device, the rejection message based on determining to reject the message mute request. In some aspects, the second device can determine to reject the message mute request based on a security check.

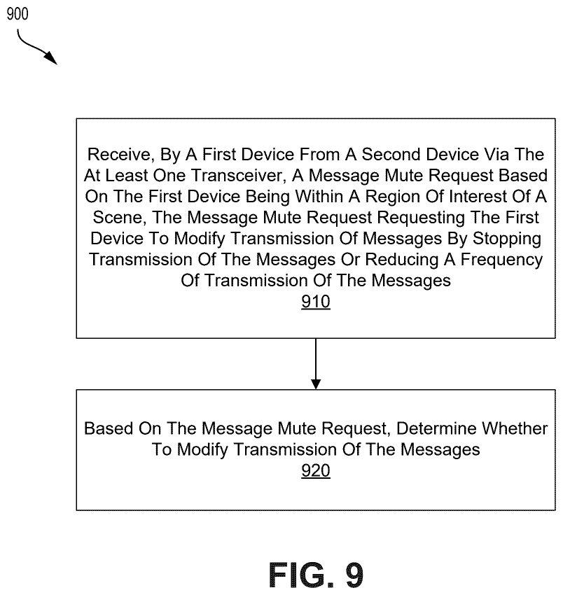

FIG. 9 is a flow chart illustrating an example of another process 900 for battery enhancements for a V2X-enabled VRU device. The process 900 can be performed by a first device (e.g., a V2X-enabled VRU device of VRU 630a, 630b, 630c of FIG. 6, first device 710 of FIG. 7, and/or a computing device or computing system 1000 of FIG. 10) or by a component or system (e.g., a chipset, one or more processors central processing units (CPUs), digital signal processors (DSPs), graphics processing units (GPUs), any combination thereof, and/or other type of processor(s), or other component or system) of the first device. The operations of the process 900 may be implemented as software components that are executed and run on one or more processors (e.g., processor 1010 of FIG. 10 or other processor(s)). Further, the transmission and reception of signals by the first device in the process 900 may be enabled, for example, by one or more antennas and/or one or more transceivers (e.g., wireless transceiver(s)).

At block 910, the first device (or component thereof, such as at least one transceiver, at least one processor via the at least one transceiver, etc.) can receive, from a second device (e.g., RSU 610 of FIG. 6, second device 720 of FIG. 7, etc.), a message mute request based on the first device being within a region of interest of a scene (e.g., with the region of interest being within a field of view of the second device). The message mute request requests the first device to modify transmission of messages (e.g., the messages are vehicle-to-everything (V2X) messages, such as pedestrian safety messages (PSMs)), such as by stopping transmission of the messages or reducing a frequency of transmission of the messages. In some aspects, the message mute request includes one or more parameters. The one or more parameters can include coordinates of a region of interest within the field of view of the second device, coordinates of a location of the second device, a timestamp indicating a time of transmission by the second device of the message mute request, one or more safety certificates for communications, a timer value indicating a duration of time for modifying the transmission of the messages, a mute bitmask indicating stopping one or more transmissions of the messages, a device identification associated with the first device, any combination thereof, and/or other parameters.

At block 920, the first device (or component thereof, such as the at least one processor) can determine whether to modify transmission of the messages based on the message mute request. In some aspects, the first device (or component thereof, such as the at least one processor) can modify transmission of the messages based on the message mute request. For instance, the first device (or component thereof, such as the at least one processor) can stop transmission of the messages or reduce a frequency of transmission of the messages. In some aspects, the message mute request includes a mute bitmask including a plurality of bits, where each bit of the plurality of bits indicating a particular message transmission the first device is not to transmit.

In some aspects, the first device (or component thereof, such as at least one transceiver, at least one processor via the at least one transceiver, etc.) can receive, from the second device via the at least one transceiver, a message resume request, the message resume request requesting the first device to resume transmission of the messages or increase the frequency of transmission of the messages. In some cases, the message resume request is based on a timer value expiring, movement of the first device by greater than a threshold amount, the first device leaving a region of interest within the field of view of the first device, any combination thereof, and/or other triggers or factors. In some aspects, the message mute request indicates a time duration for the modifying the transmission of the messages by the second device. For example, after the time duration ends, the first device can resume transmission of the messages or increase the frequency of transmission of the messages (e.g., to a frequency at which the second device transmitted messages prior to the message mute request). Based on the message resume request or expiration of the time duration indicated in the message mute request, the first device (or component thereof, such as at least one transceiver, at least one processor via the at least one transceiver, etc.) can resume transmission of the messages or increase the frequency of transmission of the messages.

In some cases, the first device (or component thereof, such as the at least one processor) can determine to reject the message mute request. For instance, in some aspects, the first device (or component thereof, such as the at least one processor) can determine to reject the message mute request based on a security check. In such cases, the first device (or component thereof, such as at least one transceiver, at least one processor via the at least one transceiver, etc.) can transmit, to the second device, a rejection message based on determining to reject the message mute request.

In some cases, the computing device (e.g., the first devices) of process 800 and/or process 900, respectively, may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 800 and/or process 900 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 800 and process 900 are each illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 800 and/or process 900 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 is a block diagram illustrating an example of a computing system 1000, which may be employed for battery enhancements for a V2X-enabled VRU device. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000.

Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1040 may also include one or more range sensors (e.g., LiDAR sensors, laser range finders, RF radars, ultrasonic sensors, and infrared (IR) sensors) configured to collect data and provide measurements to processor 1010, whereby processor 1010 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents.

Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one clement may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:
Aspect 1. A first device for wireless communications, the first device comprising: at least one transceiver; at least one memory; and at least one processor coupled to the at least one transceiver and the at least one memory, the at least one processor configured to: detect a second device within a region of interest of a scene; and based on detecting the second device within the region of interest of the scene, transmit, via the at least one transceiver, a message mute request to the second device, the message mute request requesting the second device to modify transmission of messages by stopping transmission of the messages or reducing a frequency of transmission of the messages.
Aspect 2. The first device of Aspect 1, wherein the region of interest is within a field of view of the first device.
Aspect 3. The first device of any of Aspects 1 or 2, wherein the at least one processor is configured to detect the second device within the region of interest based on one or more images captured by the first device.
Aspect 4. The first device of any of Aspects 1 to 3, wherein the at least one processor is configured to transmit, via the at least one transceiver, a message resume request to the second device, the message resume request requesting the second device to resume transmission of the messages or increase the frequency of transmission of the messages.
Aspect 5. The first device of Aspect 4, wherein the message resume request is transmitted based on at least one of determining a timer value has expired, detecting movement of the second device by greater than a threshold amount, or detecting the second device leaving the region of interest.
Aspect 6. The first device of Aspect 5, wherein, to detect the movement of the second device by greater than the threshold amount, the at least one processor is configured to detect at least one of a heading or speed of the second device changes by more than the threshold amount.
Aspect 7. The first device of any of Aspects 5 or 6, wherein the at least one processor is configured to detect the second device is leaving the region of interest based on determining the second device is within a threshold distance from an edge of the region of interest.
Aspect 8. The first device of any of Aspects 1 to 7, wherein the message mute request indicates a time duration for the modifying the transmission of the messages by the second device.
Aspect 9. The first device of any of Aspects 1 to 8, wherein the at least one processor is configured to transmit, via the at least one transceiver, messages for the second device in response to transmitting the message mute request.
Aspect 10. The first device of Aspect 9, wherein the at least one processor is configured to cease transmission of the messages for the second device in response to transmitting a message resume request requesting the second device to resume transmission of the messages.
Aspect 11. The first device of any of Aspects 1 to 10, wherein the message mute request comprises one or more parameters, the one or more parameters comprising at least one of coordinates of the region of interest, coordinates of a location of the first device, a timestamp indicating a time of transmission by the first device of the message mute request, one or more safety certificates for communications, a timer value indicating a duration of time for modifying the transmission of the messages, a mute bitmask indicating stopping one or more transmissions of the messages, a device identification associated with the second device, or any combination thereof.
Aspect 12. The first device of any of Aspects 1 to 11, wherein the message mute request comprises a mute bitmask including a plurality of bits, each bit of the plurality of bits indicating a particular message transmission the second device is not to transmit.
Aspect 13. The first device of any of Aspects 1 to 12, wherein the at least one processor is configured to receive, via the at least one transceiver, a rejection message from the second device indicating rejection of the message mute request by the second device.
Aspect 14. The first device of any of Aspects 1 to 13, wherein the messages are vehicle-to-everything (V2X) messages.
Aspect 15. The first device of any of Aspects 1 to 14, wherein the first device is a roadside unit (RSU) and wherein the second device is associated with a vulnerable road user (VRU).
Aspect 16. A method of wireless communications at a first device, the method comprising: detecting a second device within a region of interest of a scene; and based on detecting the second device within the region of interest of the scene, transmitting a message mute request to the second device, the message mute request requesting the second device to modify transmission of messages by stopping transmission of the messages or reducing a frequency of transmission of the messages.
Aspect 17. The method of Aspect 16, wherein the region of interest is within a field of view of the first device.
Aspect 18. The method of any of Aspects 16 or 17, further comprising detecting the second device within the region of interest based on one or more images captured by the first device.
Aspect 19. The method of any of Aspects 16 to 18, further comprising transmitting a message resume request to the second device, the message resume request requesting the second device to resume transmission of the messages or increase the frequency of transmission of the messages.
Aspect 20. The method of Aspect 19, wherein the message resume request is transmitted based on at least one of determining a timer value has expired, detecting movement of the second device by greater than a threshold amount, or detecting the second device leaving the region of interest.
Aspect 21. The method of Aspect 20, wherein detecting the movement of the second device by greater than the threshold amount comprises detecting at least one of a heading or speed of the second device changes by more than the threshold amount.
Aspect 22. The method of any of Aspects 20 or 21, further comprising detecting the second device is leaving the region of interest based on determining the second device is within a threshold distance from an edge of the region of interest.
Aspect 23. The method of any of Aspects 16 to 22, wherein the message mute request indicates a time duration for the modifying the transmission of the messages by the second device.
Aspect 24. The method of any of Aspects 16 to 23, further comprising transmitting messages for the second device in response to transmitting the message mute request.
Aspect 25. The method of Aspect 24, further comprising ceasing transmission of the messages for the second device in response to transmitting a message resume request requesting the second device to resume transmission of the messages.
Aspect 26. The method of any of Aspects 16 to 25, wherein the message mute request comprises one or more parameters, the one or more parameters comprising at least one of coordinates of the region of interest, coordinates of a location of the first device, a timestamp indicating a time of transmission by the first device of the message mute request, one or more safety certificates for communications, a timer value indicating a duration of time for modifying the transmission of the messages, a mute bitmask indicating stopping one or more transmissions of the messages, a device identification associated with the second device, or any combination thereof.
Aspect 27. The method of any of Aspects 16 to 26, wherein the message mute request comprises a mute bitmask including a plurality of bits, each bit of the plurality of bits indicating a particular message transmission the second device is not to transmit.
Aspect 28. The method of any of Aspects 16 to 27, further comprising receiving a rejection message from the second device indicating rejection of the message mute request by the second device.
Aspect 29. The method of any of Aspects 16 to 28, wherein the messages are vehicle-to-everything (V2X) messages.
Aspect 30. The method of any of Aspects 16 to 29, wherein the first device is a roadside unit (RSU) and wherein the second device is associated with a vulnerable road user (VRU).
Aspect 31. A first device for wireless communications, the first device comprising: at least one transceiver; at least one memory; and at least one processor coupled to the at least one transceiver and the at least one memory, the at least one processor configured to: receive, from a second device via the at least one transceiver, a message mute request based on the first device being within a region of interest of a scene, the message mute request requesting the first device to modify transmission of messages by stopping transmission of the messages or reducing a frequency of transmission of the messages; and based on the message mute request, determine whether to modify transmission of the messages
Aspect 32. The first device of Aspect 31, wherein the at least one processor is configured to modify transmission of the messages based on the message mute request.
Aspect 33. The first device of Aspect 32, wherein, to modify transmission of the messages, the at least one processor is configured to stop transmission of the messages or reduce a frequency of transmission of the messages.
Aspect 34. The first device of any of Aspects 31 to 33, wherein the at least one processor is configured to: transmit, to the second device via the at least one transceiver, a rejection message based on a determination to reject the message mute request.
Aspect 35. The first device of Aspect 34, wherein the at least one processor is configured to determine to reject the message mute request based on a security check.
Aspect 36. The first device of any of Aspects 31 to 35, wherein the message mute request comprises one or more parameters, the one or more parameters comprising at least one of coordinates of a region of interest within the field of view of the second device, coordinates of a location of the second device, a timestamp indicating a time of transmission by the second device of the message mute request, one or more safety certificates for communications, a timer value indicating a duration of time for modifying the transmission of the messages, a mute bitmask indicating stopping one or more transmissions of the messages, or a device identification associated with the first device.
Aspect 37. The first device of any of Aspects 31 to 36, wherein the message mute request comprises a mute bitmask including a plurality of bits, each bit of the plurality of bits indicating a particular message transmission the first device is not to transmit.
Aspect 38. The first device of any of Aspects 31 to 37, wherein the at least one processor is configured to receive, from the second device via the at least one transceiver, a message resume request, the message resume request requesting the first device to resume transmission of the messages; and based on the message resume request, resume transmission of the messages.
Aspect 39. The first device of Aspect 38, wherein the message resume request is based on at least one of a timer value expiring, movement of the first device by greater than a threshold amount, or the first device leaving a region of interest within the field of view of the first device.
Aspect 40. The first device of any of Aspects 31 to 39, wherein the messages are vehicle-to-everything (V2X) messages.
Aspect 41. The first device of Aspect 40, wherein the V2X messages include pedestrian safety messages (PSMs).
Aspect 42. The first device of any of Aspects 31 to 41, wherein the first device is associated with a vulnerable road user (VRU).
Aspect 43. The first device of any of Aspects 31 to 42, wherein the second device is a roadside unit (RSU).
Aspect 44. A method of wireless communications at a first device, the method comprising: receiving, from a second device, a message mute request based on the first device being within a region of interest of a scene, the message mute request requesting the first device to modify transmission of messages by stopping transmission of the messages or reducing a frequency of transmission of the messages; and based on the message mute request, determining whether to modify transmission of the messages
Aspect 45. The method of Aspect 44, further comprising modifying transmission of the messages based on the message mute request.
Aspect 46. The method of Aspect 45, wherein modifying transmission of the messages comprises stopping transmission of the messages or reducing a frequency of transmission of the messages.
Aspect 47. The method of any of Aspects 44 to 46, further comprising: transmitting, to the second device, a rejection message based on a determination to reject the message mute request.
Aspect 48. The method of Aspect 47, further comprising determining to reject the message mute request based on a security check.
Aspect 49. The method of any of Aspects 44 to 48, wherein the message mute request comprises one or more parameters, the one or more parameters comprising at least one of coordinates of a region of interest within the field of view of the second device, coordinates of a location of the second device, a timestamp indicating a time of transmission by the second device of the message mute request, one or more safety certificates for communications, a timer value indicating a duration of time for modifying the transmission of the messages, a mute bitmask indicating stopping one or more transmissions of the messages, or a device identification associated with the first device.
Aspect 50. The method of any of Aspects 44 to 49, wherein the message mute request comprises a mute bitmask including a plurality of bits, each bit of the plurality of bits indicating a particular message transmission the first device is not to transmit.
Aspect 51. The method of any of Aspects 44 to 50, further comprising receiving, from the second device, a message resume request, the message resume request requesting the first device to resume transmission of the messages; and based on the message resume request, resume transmission of the messages.
Aspect 52. The method of Aspect 51, wherein the message resume request is based on at least one of a timer value expiring, movement of the first device by greater than a threshold amount, or the first device leaving a region of interest within the field of view of the first device.
Aspect 53. The method of any of Aspects 44 to 52, wherein the messages are vehicle-to-everything (V2X) messages.
Aspect 54. The method of Aspect 53, wherein the V2X messages include pedestrian safety messages (PSMs).
Aspect 55. The method of any of Aspects 44 to 54, wherein the first device is associated with a vulnerable road user (VRU).
Aspect 56. The method of any of Aspects 44 to 55, wherein the second device is a roadside unit (RSU).
Aspect 57. A non-transitory computer-readable medium having stored thereon instructions that, when executed by at least one processor, cause the at least one processor to perform operations according to any of Aspects 16 to 30.
Aspect 58. An apparatus for wireless communications, the apparatus including one or more means for performing operations according to any of Aspects 16 to 30.
Aspect 59. A non-transitory computer-readable medium having stored thereon instructions that, when executed by at least one processor, cause the at least one processor to perform operations according to any of Aspects 44 to 56.
Aspect 60. An apparatus for wireless communications, the apparatus including one or more means for performing operations according to any of Aspects 44 to 56.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A first device for wireless communications, the first device comprising:
at least one transceiver;
at least one memory; and
at least one processor coupled to the at least one transceiver and the at least one memory, the at least one processor configured to:
detect a second device within a region of interest of a scene; and
based on detecting the second device within the region of interest of the scene, transmit, via the at least one transceiver, a message mute request to the second device, the message mute request requesting the second device to modify transmission of messages by stopping transmission of the messages or reducing a frequency of transmission of the messages.

2. The first device of claim 1, wherein the region of interest is within a field of view of the first device.

3. The first device of claim 1, wherein the at least one processor is configured to detect the second device within the region of interest based on one or more images captured by the first device.

4. The first device of claim 1, wherein the at least one processor is configured to transmit, via the at least one transceiver, a message resume request to the second device, the message resume request requesting the second device to resume transmission of the messages or increase the frequency of transmission of the messages.

5. The first device of claim 4, wherein the message resume request is transmitted based on at least one of determining a timer value has expired, detecting movement of the second device by greater than a threshold amount, or detecting the second device leaving the region of interest.

6. The first device of claim 5, wherein, to detect the movement of the second device by greater than the threshold amount, the at least one processor is configured to detect at least one of a heading or speed of the second device changes by more than the threshold amount.

7. The first device of claim 5, wherein the at least one processor is configured to detect the second device is leaving the region of interest based on determining the second device is within a threshold distance from an edge of the region of interest.

8. The first device of claim 1, wherein the message mute request indicates a time duration for the modifying the transmission of the messages by the second device.

9. The first device of claim 1, wherein the at least one processor is configured to transmit, via the at least one transceiver, messages for the second device in response to transmitting the message mute request.

10. The first device of claim 9, wherein the at least one processor is configured to cease transmission of the messages for the second device in response to transmitting a message resume request requesting the second device to resume transmission of the messages.

11. The first device of claim 1, wherein the message mute request comprises one or more parameters, the one or more parameters comprising at least one of coordinates of the region of interest, coordinates of a location of the first device, a timestamp indicating a time of transmission by the first device of the message mute request, one or more safety certificates for communications, a timer value indicating a duration of time for modifying the transmission of the messages, a mute bitmask indicating stopping one or more transmissions of the messages, a device identification associated with the second device, or any combination thereof.

12. The first device of claim 1, wherein the message mute request comprises a mute bitmask including a plurality of bits, each bit of the plurality of bits indicating a particular message transmission the second device is not to transmit.

13. The first device of claim 1, wherein the at least one processor is configured to receive, via the at least one transceiver, a rejection message from the second device indicating rejection of the message mute request by the second device.

14. The first device of claim 1, wherein the messages are vehicle-to-everything (V2X) messages.

15. The first device of claim 1, wherein the first device is a roadside unit (RSU) and wherein the second device is associated with a vulnerable road user (VRU).

16. A method of wireless communications at a first device, the method comprising:
detecting a second device within a region of interest of a scene; and
based on detecting the second device within the region of interest of the scene, transmitting a message mute request to the second device, the message mute request requesting the second device to modify transmission of messages by stopping transmission of the messages or reducing a frequency of transmission of the messages.

17. The method of claim 16, further comprising transmitting a message resume request to the second device, the message resume request requesting the second device to resume transmission of the messages or increase the frequency of transmission of the messages.

18. The method of claim 17, further comprising:
transmitting messages for the second device in response to transmitting the message mute request; and
ceasing transmission of the messages for the second device in response to transmitting the message resume request.

19. A first device for wireless communications, the first device comprising:
at least one transceiver;
at least one memory; and
at least one processor coupled to the at least one transceiver and the at least one memory, the at least one processor configured to:
receive, from a second device via the at least one transceiver, a message mute request based on the first device being within a region of interest of a scene, the message mute request requesting the first device to modify transmission of messages by stopping transmission of the messages or reducing a frequency of transmission of the messages; and
based on the message mute request, determine whether to modify transmission of the messages.

20. The first device of claim 19, wherein the at least one processor is configured to:
receive, from the second device via the at least one transceiver, a message resume request, the message resume request requesting the first device to resume transmission of the messages or increase the frequency of transmission of the messages; and
based on the message resume request, resume transmission of the messages or increase the frequency of transmission of the messages.
